(19) United States
(12) Patent Application Publication
(10) Pub. No.: US 2022/0143707 A1
(43) Pub. Date: May 12, 2022

(54) ADDITIVE MANUFACTURING

(71) Applicant: Sodick Co., Ltd., Kanagawa (JP)

(72) Inventors: Yasuyuki MIYASHITA, Kanagawa (JP); Shuji OKAZAKI, Kanagawa (JP); Ichiro ARAIE, Kanagawa (JP); Shuichi KAWADA, Kanagawa (JP); Katsutaka MURANAKA, Kanagawa (JP)

(73) Assignee: Sodick Co., Ltd., Kanagawa (JP)

(21) Appl. No.: 17/518,523

(22) Filed: Nov. 3, 2021

(30) Foreign Application Priority Data
Nov. 12, 2020 (JP) 2020-188797

(51) Int. Cl. B22F 10/85; B22F 10/28; B22F 12/41; B33Y 10/00; B33Y 30/00; B33Y 50/02

(52) U.S. Cl. CPC B22F 10/85; B22F 10/28; B22F 12/41; B22F 2201/10; B33Y 30/00; B33Y 50/02; B33Y 10/00

(57) ABSTRACT

An additive manufacturing apparatus of the disclosure includes: a data acquiring device which acquires at least one of first data showing an irradiation state of a laser beam, second data showing an inert gas state, and third data showing a formation state of a material layer and fourth data showing a manufacturing position state; and a determination device which determines whether or not there is an abnormality in a manufacturing state of a solidified layer based on the fourth data and identifies factors of abnormalities from the operating state of the additive manufacturing apparatus to the manufacturing state of the solidified layer based on at least one of the acquired first to third data.

### CROSS-REFERENCE TO RELATED APPLICATIONS

This application claims the priority benefit of Japanese Patent Application No. 2020-188797, filed on Nov. 12, 2020. The entirety of the above-mentioned patent application is hereby incorporated by reference herein and made a part of this specification.

### BACKGROUND

### Technical Field

The disclosure relates to an additive manufacturing apparatus and a method of producing an additive manufactured object.

### Description of Related Art

Various methods are known for additive manufacturing of three-dimensional manufactured objects. For example, a material layer is formed by supplying metal powder to a manufacturing region on a manufacturing table in a chamber filled with an inert gas and a solidified layer is formed by melting or sintering the material layer by the irradiation of a laser beam to a predetermined position of the material layer. Then, a desired three-dimensional manufactured object is produced by manufacturing the solidified layer in such a manner that the material layer and the solidified layer are repeatedly formed.

Conventionally, metal additive manufacturing is mainly used to produce prototypes, but in recent years, the fields of application have been expanding. For example, in the medical and aviation fields, there are increasing opportunities to produce parts by additive manufacturing. With the expansion of such application fields, quality assurance and quality control of manufactured objects have become more important.

For the purpose of quality assurance, the manufactured objects obtained after additive manufacturing are inspected. For example, by performing a CT scan with X-rays on the additive manufactured object, it is possible to investigate the presence or absence of internal voids that affect the mechanical strength of the manufactured object. On the other hand, in the production stage, it is necessary to stably operate an additive manufacturing apparatus for quality control. Patent Document 1 (U.S. Pat. No. 9,592,636 B2) discloses an additive manufacturing apparatus capable of removing fume causing sintering defects from an irradiation path of a laser beam while maintaining an inert gas environment.

### PATENT DOCUMENTS

Patent Document 1: U.S. Pat. No. 9,592,636 B2

### SUMMARY

It is known that many of abnormalities in the quality of additive manufactured objects such as voids are caused by abnormalities in the manufacturing state that occur in the production stage of the additive manufactured objects, that is, in the process of additive manufacturing. Therefore, if the abnormality in the manufacturing state of the solidified layer can be monitored in real time and detected at the generation stage, it is possible to take appropriate measures at the production stage and suppress the occurrence of defective products.

On the other hand, even if the abnormality in the manufacturing state can be detected, there are various possibilities of the abnormality. As a result, it takes a considerable amount of time to identify the abnormality. Thus, if it is possible to monitor the operating state of the additive manufacturing apparatus which can be a factor of the abnormality in parallel with the monitoring of the abnormality in the manufacturing state, it is possible to identify the factor at an early stage when an abnormality occurs and take appropriate measures. For example, examples of appropriate measures include an operation of cleaning and replacing a chamber window through which a laser beam is transmitted and which protects a laser irradiation device from fume, an operation of cleaning a fume collector removing fume in the chamber, an operation of replacing a filter of the fume collector, and an operation of correcting various operation commands of the apparatus.

The disclosure has been made in view of such circumstances and a main objective is to provide an additive manufacturing apparatus capable of monitoring a manufacturing state in the process of additive manufacturing and an operating state of the additive manufacturing apparatus, determining whether or not there is an abnormality in the manufacturing state, and identifying a factor of an abnormality and a method of producing an additive manufactured object. Additional objects and advantages of the disclosure will be set forth in the description that follows.

According to the disclosure, there is provided an additive manufacturing apparatus including: a chamber; a manufacturing table; an inert gas supply device; a fume collector; a recoater head; a laser irradiation device; a data acquiring device; and a determination device, wherein the chamber covers a manufacturing region, has a chamber window provided on a ceiling, and is filled with an inert gas having a predetermined concentration, wherein the manufacturing table is disposed in the manufacturing region and moves in an up and down direction, wherein the recoater head forms a material layer by supplying material powder onto the manufacturing region, wherein the laser irradiation device forms a solidified layer by irradiating a manufacturing position of the material layer with a laser beam through the chamber window, wherein the inert gas supply device supplies a new inert gas into the chamber, wherein the fume collector removes fume from an inert gas discharged from the chamber together with the fume generated when forming the solidified layer and returns the inert gas from which the fume is removed to the chamber, wherein the data acquiring device acquires at least one of first data showing an irradiation state of the laser beam, second data showing an inert gas state, and third data showing a formation state of the material layer and fourth data showing a manufacturing position state by measurement, and wherein the determination device determines whether or not there is an abnormality in a manufacturing state of the solidified layer based on the fourth data and when it is determined that there is an abnormality in the manufacturing state, factors of abnormalities from an operating state of the additive manufacturing apparatus to the manufacturing state of the solidified layer are identified based on at least one of the acquired first to third data.

According to another aspect of the disclosure, there is provided a method of producing an additive manufactured object including: a material layer forming step; a solidified layer forming step; a data acquiring step; and a determination step, wherein in the material layer forming step, a material layer is formed by supplying material powder onto a manufacturing region by a recoater head in a chamber which covers the manufacturing region, has a chamber window provided on a ceiling, and is filled with an inert gas having a predetermined concentration, wherein in the solidified layer forming step, a solidified layer is formed by irradiating a manufacturing position of the material layer with a laser beam through the chamber window, wherein in the data acquiring step, at least one of first data showing an irradiation state of the laser beam, second state showing an inert gas state, and third data showing a formation state of the material layer and fourth data showing a manufacturing position state are acquired by measurement, and wherein in the determination step, it is determined whether or not there is an abnormality in a manufacturing state of the solidified layer based on the fourth data and when it is determined that there is an abnormality in the manufacturing state, factors of abnormalities from an operating state of the additive manufacturing apparatus to the manufacturing state of the solidified layer are identified based on at least one of the acquired first to third data.

In the additive manufacturing apparatus and the method of producing the additive manufactured object according to the disclosure, at least one of the first data showing the irradiation state of the laser beam, the second data showing the inert gas state, and the third data showing the formation state of the material layer and the fourth data showing the manufacturing position state are acquired by measurement, the abnormality in the manufacturing state of the solidified layer is determined based on the fourth data, and when it is determined that there is an abnormality in the manufacturing state, the factors of the abnormalities from the operating state of the additive manufacturing apparatus to the manufacturing state of the solidified layer are identified based on at least one of the acquired first to third data. With such a configuration, since it is possible to detect an abnormality in the manufacturing state in the process of additive manufacturing at the generation stage and to identify the factor of the abnormality at an early stage, it is easy for quality control in the production stage of the manufactured object.

### BRIEF DESCRIPTION OF THE DRAWINGS

FIG. 1 is a schematic configuration diagram of an additive manufacturing apparatus 1 according to an embodiment of the disclosure.

FIG. 2 is a schematic configuration diagram of the additive manufacturing apparatus 1 according to the embodiment of the disclosure.

FIG. 3 is a perspective view of a material layer forming device 3.

FIG. 4 is a perspective view of a recoater head 32 when viewed from above.

FIG. 5 is a perspective view of the recoater head 32 when viewed from below.

FIG. 6 is a schematic configuration diagram of a laser irradiation device 7.

FIG. 7 is a block diagram showing a configuration of a control device 9.

FIG. 8 is a diagram illustrating an allowable range of first data at the time of monitoring an operating state according to the embodiment.

FIG. 9 is a diagram illustrating an allowable range of first data at the time of identifying an abnormal factor according to the embodiment.

FIG. 10 is a diagram illustrating an allowable range of second data at the time of monitoring an operating state according to the embodiment.

FIG. 11 is a diagram illustrating an allowable range of second data at the time of identifying an abnormal factor according to the embodiment.

FIG. 12 is a diagram illustrating an allowable range of third data at the time of monitoring an operating state according to the embodiment.

FIG. 13 is a diagram illustrating an allowable range of third data at the time of identifying an abnormal factor according to the embodiment.

FIG. 14 is a diagram illustrating an allowable range of fourth data according to the embodiment.

FIG. 15 is a flowchart showing an additive manufactured object manufacturing method and an operating state monitoring sequence according to the embodiment of the disclosure.

FIG. 16 is a flowchart showing a procedure of monitoring a manufacturing state and identifying an abnormal factor of the manufacturing state according to the embodiment of the disclosure.

### DESCRIPTION OF THE EMBODIMENTS

Hereinafter, an embodiment of the disclosure will be described with reference to the drawings. The features shown in the embodiment below can be combined with each other. In addition, the disclosure is independently established for each feature.

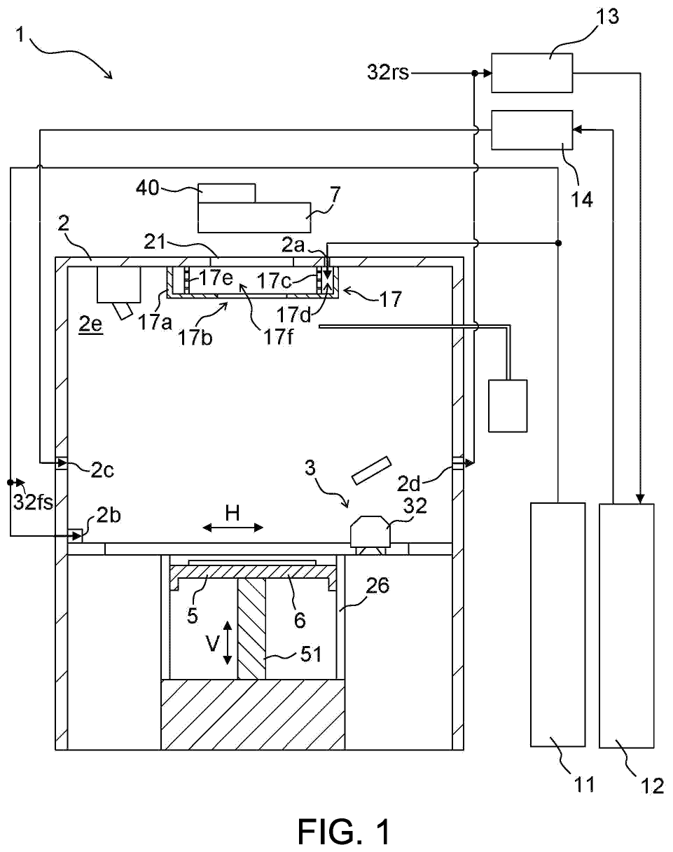

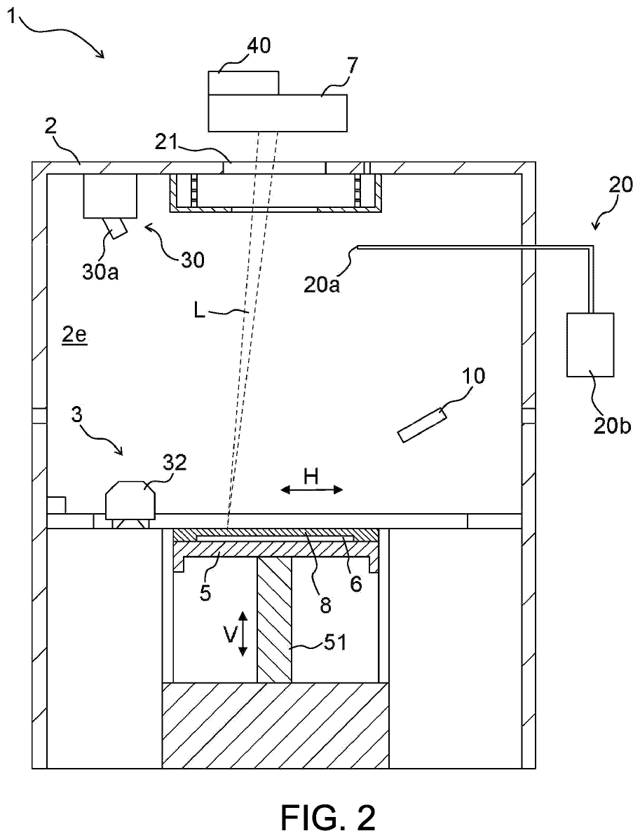

FIGS. 1 and 2 are schematic configuration diagrams of an additive manufacturing apparatus 1 according to the embodiment. The additive manufacturing apparatus 1 includes at least a chamber 2, a material layer forming device 3, and a laser irradiation device 7. For example, the additive manufacturing apparatus 1 includes the chamber 2, a manufacturing table 5, an inert gas supply device 11, a fume collector 12, a recoater head 32, the laser irradiation device 7, a data acquiring device 97, and a determination device 91c. Further, in the additive manufacturing apparatus 1, a machining device (not shown) for performing machining such as cutting on a solidified layer and an additive manufactured object to be described later may be provided in the chamber 2 as necessary. The machining device performs machining on the solidified layer or the additive manufactured object by moving a machining head (not shown) provided with a tool (not shown) for performing machining such as a cutting tool. The machining head may be configured, for example, in the X-axis direction parallel to the upper surface of the solidified layer. Further, the machining head may be further configured to move, for example, in the Y-axis direction orthogonal to the X-axis direction and parallel to the upper surface of the solidified layer. Further, the machining head may be further configured to move, for example, in the Z-axis direction perpendicular to the upper surface of the solidified layer. Further, the machining head may be further configured to include, for example, a spindle rotating about the Z axis. The tool for performing machining may be configured to rotate while being attached to the spindle.

The chamber 2 covers a manufacturing region R which is a region where a desired additive manufactured object is formed and the inside thereof is filled with an inert gas of a predetermined concentration supplied from the inert gas supply device 11. In the present specification, the inert gas is a gas that does not substantially react with a material layer 8 or the solidified layer and is selected according to the type of molding material. For example, a nitrogen gas, an argon gas, or a helium gas can be used. In the metal additive manufacturing, it is necessary to maintain the oxygen concentration around the manufacturing region R as low as possible in order to suppress the deterioration of the material powder and enable stable irradiation of the laser beam L. By filling the chamber 2 with the inert gas, the oxygen concentration can be kept sufficiently low. Additionally, the inert gas discharged from the chamber 2 is sent to a fume collector 12 to be described later and is supplied to the chamber 2 to be used again after removing the fume therefrom.

A chamber window 21 through which a laser beam L output from the laser irradiation device 7 is transmitted is provided on a ceiling of the chamber 2. The chamber window 21 is formed of a material through which the laser beam L can be transmitted and quartz glass, borosilicate glass, germanium, silicon, zinc selenium, potassium bromide crystals, or the like is selected as a material depending on the type of laser beam L. For example, when the laser beam L is a fiber laser or a YAG laser, the chamber window 21 can be made of quartz glass.

A fume diffuser 17 is further provided inside the ceiling of the chamber 2 to cover the chamber window 21. The fume diffuser 17 includes a cylindrical housing 17a and a cylindrical diffusion member 17c disposed inside the housing 17a. An inert gas supply space 17d is provided between the housing 17a and the diffusion member 17c. In a bottom surface of the housing 17a, an opening 17b is provided inside the diffusion member 17c. A plurality of pores 17e is provided in the diffusion member 17c and a clean inert gas supplied from the inert gas supply space 17d is filled in a clean room 17f through the pores 17e and is ejected toward the lower side of the fume diffuser 17 through the opening 17b. With such a configuration, it is possible to prevent the fume from adhering to the chamber window 21 and remove the fume from the irradiation path of the laser beam L.

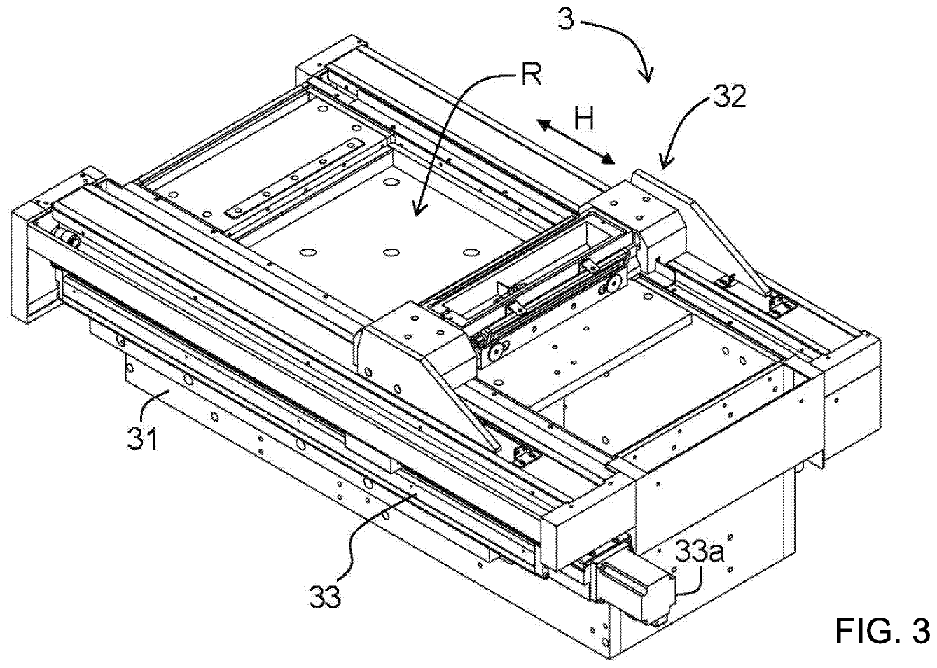

The material layer forming device 3 is provided inside the chamber 2. As shown in FIGS. 1 to 3, the material layer forming device 3 includes a base 31 and a recoater head 32 disposed on the base 31. The base 31 has a manufacturing region R where the additive manufactured object is formed and the manufacturing region R is provided with the manufacturing table 5. The manufacturing table 5 is driven by a manufacturing table driving mechanism 51 and is movable in the up and down direction (a direction indicated by an arrow V in FIG. 1). In the additive manufacturing, a base plate 6 is disposed on the manufacturing table 5 and the material layer 8 is formed on the upper surface of the base plate 6.

A powder holding wall 26 is provided around the manufacturing table 5. Unsolidified material powder is held in a powder holding space surrounded by the powder holding wall 26 and the manufacturing table 5. An opening (not shown) is provided on the lower side of the powder holding wall 26 to discharge the material powder in the powder holding space to the outside of the powder holding space and unsolidified material powder is discharged from the opening by lowering the manufacturing table 5 to the opening after the additive manufacturing is completed.

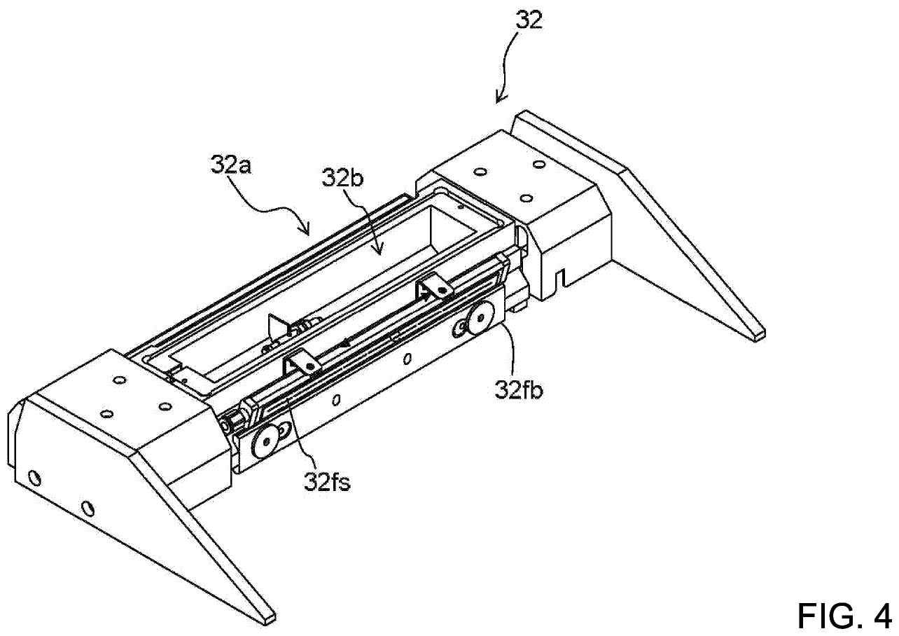

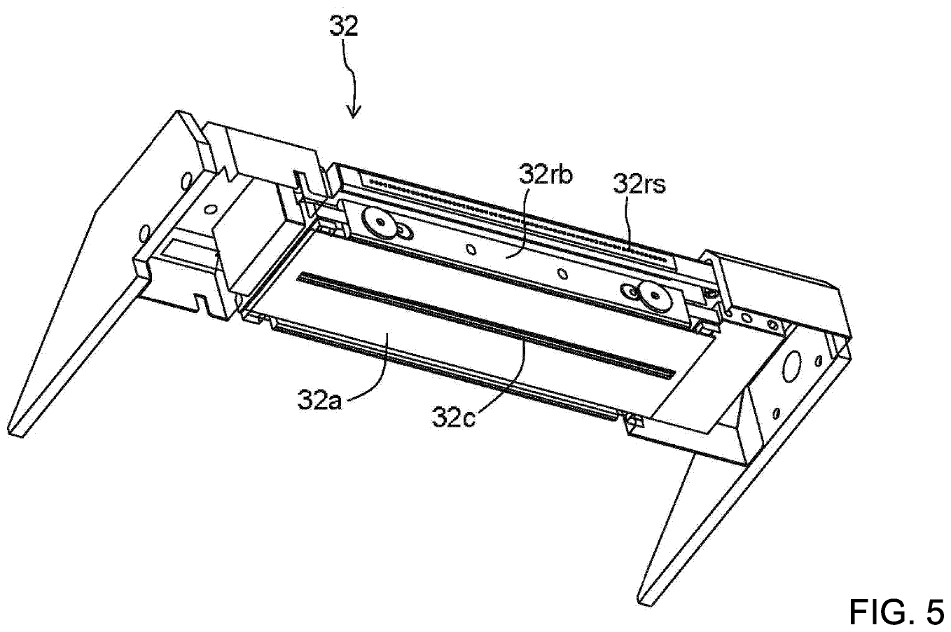

As shown in FIG. 1 and FIGS. 3 to 5, the recoater head 32 is configured to be movable in a reciprocating manner in the horizontal uniaxial direction (a direction indicated by an arrow H) by a recoater head driving mechanism 33 and includes a material storage member 32a forming a material storage space, a material supply port 32b, and a material discharge port 32c. The recoater head driving mechanism 33 includes a motor 33a for moving the recoater head 32 and is controlled by a recoater head control device 94 to be described later.

The material supply port 32b is provided on the upper surface of the material storage member 32a and serves as a port that receives material powder supplied from a material supply unit (not shown) to the material storage space of the material storage member 32a. The material discharge port 32c is provided on a bottom surface of the material storage member 32a and discharges the material powder in the material storage space of the material storage member 32a. The material discharge port 32c has a slit shape extending in the longitudinal direction of the material storage member 32a. Blades 32fb and 32rb are provided on both side surfaces of the recoater head 32. The blades 32fb and 32rb flatten the material powder discharged from the material discharge port 32c to form the material layer 8. The recoater head 32 forms the material layer 8 by supplying unsolidified material powder onto the manufacturing region R.

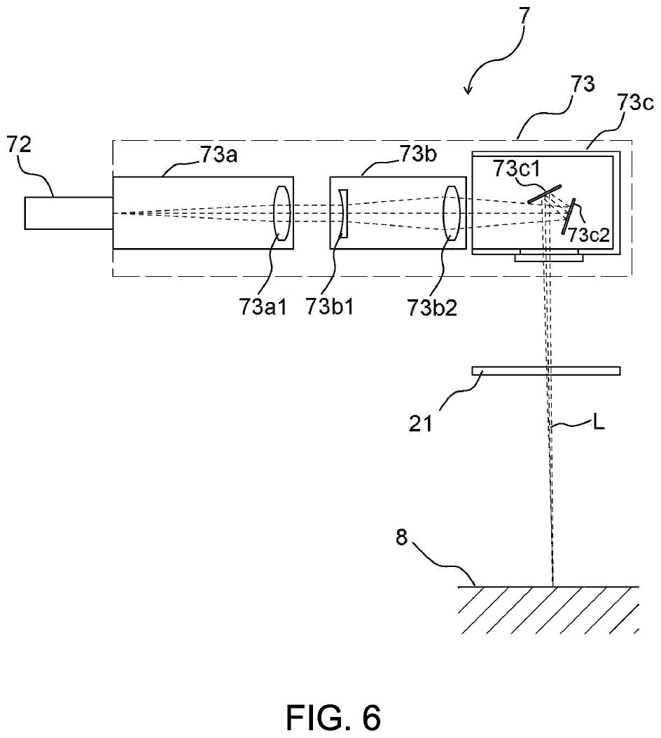

As shown in FIGS. 1 and 2, the laser irradiation device 7 is provided above the chamber 2. The laser irradiation device 7 irradiates a predetermined position of the material layer 8 formed on the manufacturing region R with a laser beam L to melt and sinter the material layer 8 at the irradiation position so that the material layer is solidified. The laser irradiation device 7 forms a solidified layer by irradiating the manufacturing position of the material layer 8 with the laser beam L through the chamber window 21. As shown in FIG. 6, the laser irradiation device 7 includes a laser oscillator 72 and a galvano unit 73 and is controlled by a laser control device 93 to be described later.

The laser oscillator 72 is attached with a laser element which serves as a laser beam source and outputs the laser beam L. The laser beam L may be any one as long as the material powder can be melted or sintered, and for example, a fiber laser, a CO₂ laser, or a YAG laser can be used.

The galvano unit 73 includes a collimator 73a, a focus control unit 73b, and a scanning device 73c. The collimator 73a has the collimator lens 73a1 provided therein and converts the laser beam L output from the laser oscillator 72 into parallel light. The focus control unit 73b includes a movable lens 73b1 and a condensing lens 73b2 therein. The movable lens 73b1 is moved in the optical axis direction of the laser beam L by a lens actuator (not shown) so that the focal position of the laser beam L converted into parallel light by the collimator 73a is adjusted to a predetermined focal position. Further, the movable lens 73b1 adjusts the focal position of the laser beam L so that the beam diameter of the laser beam L on the surface of the material layer 8 is adjusted to a predetermined beam diameter. The movable lens 73b1 is movable in the optical axis direction of the laser beam L by a lens actuator (not shown), so that the focal position of the laser beam L can be adjusted. The condensing lens 73b2 condenses the laser beam L having passed through the movable lens 73b1. Additionally, in this embodiment, the movable lens 73b1 is a diffusion lens having a concave surface on the upstream side and a flat surface on the downstream side along the path of the laser beam L from the laser oscillator 72, but the type of lens can be appropriately selected depending on the intended use and may be a condensing lens.

The scanning device 73c includes a first galvano mirror 73c1, a second galvano mirror 73c2, a first actuator (not shown) rotating the first galvano mirror 73c1 to a desired angle, and a second actuator (not shown) rotating the second galvano mirror 73c2 to a desired angle and two-dimensionally scans the upper surface of the material layer 8 in the manufacturing region R so that the laser beam L having passed through the focus control unit 73b can be controlled. That is, the laser beam L having passed through the focus control unit 73b is scanned in a first direction by the first galvano mirror 73c1 and is scanned in a second direction by the second galvano mirror 73c2 when the upper surface of the material layer 8 is irradiated with the laser beam. The laser beam L reflected by the first galvano mirror 73c1 and the second galvano mirror 73c2 is transmitted through the chamber window 21 to irradiate a predetermined position of the material layer 8 in the manufacturing region R, so that a solidified layer is formed. Additionally, for example, when the upper surface of the material layer 8 in the manufacturing region R is a plane formed by X and Y axes orthogonal to each other, the first galvano mirror 73c1 and the second galvano mirror 73c2 may be configured so that one of them scans the irradiation position of the laser beam L in the direction of the X axis and the other of them scans the irradiation position of the laser beam L in the direction of the Y axis. Further, the laser irradiation device 7 is not limited to the above-described form and, for example, may be configured to use an fθ lens instead of the focus control unit 73b.

Next, the inert gas supply system to the chamber 2 and the fume discharge system from the chamber 2 will be described.

As shown in FIG. 1, the inert gas supply device 11 and the fume collector 12 are connected to the inert gas supply system to the chamber 2. The inert gas supply device 11 has a function of supplying an inert gas and is, for example, a gas cylinder. The inert gas supply device 11 supplies a new inert gas into the chamber 2. The fume collector 12 has a function of removing the fume in the inert gas and for example, a dry electrostatic precipitator and a filtration dust collector provided with a filter can be used. The fume collector 12 removes the fume from the inert gas discharged from the chamber 2 together with the fume generated when forming the solidified layer and returns the inert gas from which the fume is removed to the chamber 2 again. The inert gas (the inert gas containing the fume) discharged from the chamber 2 through the fume discharge system to be described later is sent to the fume collector 12 through a duct box 13 connected to the upstream of the fume collector 12 and the inert gas from which the fume is removed is sent to the chamber 2 through a duct box 14 connected to the downstream of the fume collector 12. With such a configuration, the inert gas can be used again. Additionally, a plurality of the fume collectors 12 may be provided to be switchable in the process of additive manufacturing.

The chamber 2 is provided with at least one supply port for a new inert gas supplied from the inert gas supply device 11, at least one supply port for the inert gas supplied from the fume collector 12 and used again, and at least one discharge port for the inert gas from the chamber 2 to the fume collector 12. In this embodiment, the inert gas from the inert gas supply device 11 is supplied through a first supply port 2a provided in the upper portion of the fume diffuser 17, a second supply port 32fs provided in one side surface of the recoater head 32, and a third supply port 2b provided in the pipe on the end surface of the base 31. Here, the pipe is attached onto the end surface of the base 31 on the side opposite to the installation side of the second supply port 32fs. Then, the supply of the inert gas to the second supply port 32fs and the third supply port 2b is selectively performed depending on the position of the recoater head 32 in the process of additive manufacturing. That is, the inert gas can be supplied through the second supply port 32fs when the irradiation region of the laser beam L is located at a position facing the second supply port 32fs and can be supplied through the third supply port 2b when the irradiation region of the laser beam L is located at a position not facing the second supply port 32fs. The inert gas from the fume collector 12 is supplied through the fourth supply port 2c provided in the side wall of the chamber 2.

With such a configuration, a new inert gas is supplied from the inert gas supply device 11 to the vicinity of the irradiation region of the laser beam L and the fume diffuser 17 provided to prevent the fume adhering to the chamber window 21. On the other hand, since the inert gas from which the fume is removed by the fume collector 12 is supplied from the fourth supply port 2c for circulating and supplying the inert gas in the chamber 2, there is an advantage that the consumption amount of the new inert gas is suppressed.

The fume discharge system from the chamber 2 is connected to a first discharge port 2d provided with an exhaust fan (not shown) and a second discharge port 32rs provided in the side surface on the side opposite to the second supply port 32fs of the recoater head 32. Since the inert gas containing the fume in the manufacturing space 2e of the chamber 2 is discharged through the first discharge port 2d, a flow of the inert gas from the fourth supply port 2c toward the first discharge port 2d is formed in the manufacturing space 2e. Further, when the irradiation region of the laser beam L is located at a position facing the second discharge port 32rs, the fume generated in the manufacturing region R can be sucked through the second discharge port 32rs.

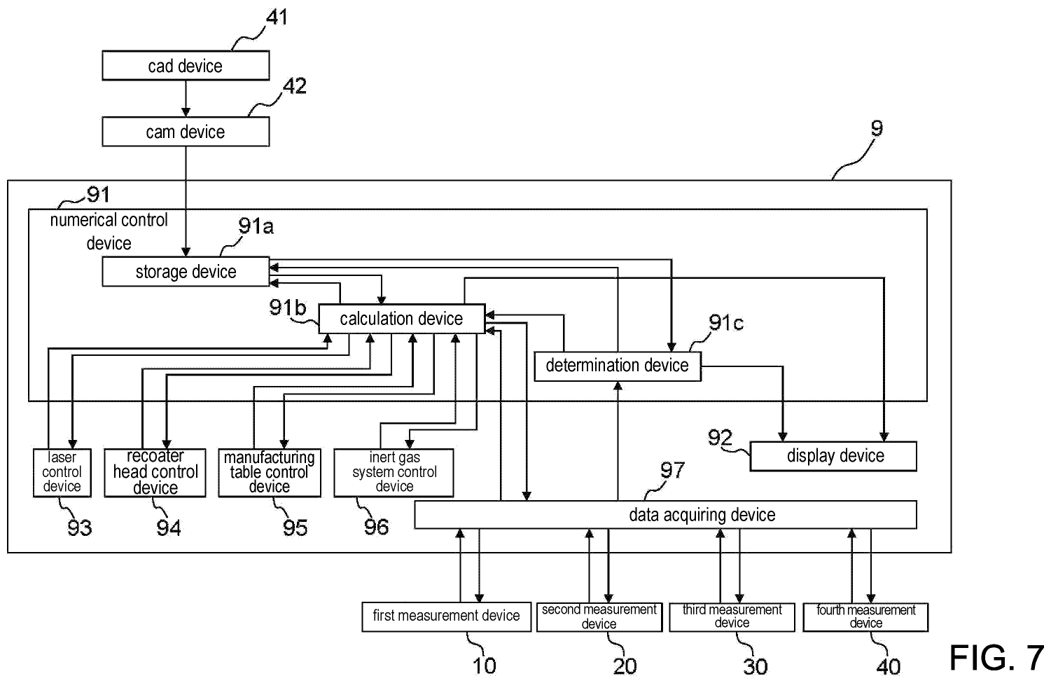

Next, the control device 9 for controlling the additive manufacturing apparatus 1 will be described. FIG. 7 is a block diagram showing a configuration of the control device 9.

As shown in FIG. 7, the control device 9 includes a numerical control device 91, a display device 92, control devices 93, 94, 95, and 96 for respective devices constituting the additive manufacturing apparatus 1, and a data acquiring device 97. The control device 9 plays a role of controlling the operation of the additive manufacturing apparatus 1 and monitoring the operating state of the additive manufacturing apparatus 1 and the manufacturing state of the solidified layer.

A CAD device 41 and a CAM device 42 are installed outside the control device 9. The CAD device 41 is for creating three-dimensional shape data (CAD data) showing the shape and dimension of the additive manufactured object of the manufacturing object. The created CAD data is output to the CAM device 42.

The CAM device 42 is for creating operation sequence data (CAM data) of each device constituting the additive manufacturing apparatus 1 at the time of manufacturing of the additive manufactured object based on the CAD data created by the CAD device 41. The CAM data includes, for example, data on the irradiation position of the laser beam L in each material layer, data on the laser irradiation condition of the laser beam L, and the like. The created CAM data is output to the numerical control device 91.

The numerical control device 91 is for performing the operation command for the additive manufacturing apparatus 1 by performing a calculation using a numerical control program on the CAM data created by the CAM device 42. The numerical control device 91 includes a storage device 91a, a calculation device 91b, and a determination device 91c. The calculation device 91b performs a calculation on the CAM data using the numerical control program stored in the storage device 91a and outputs an operation command to the control devices 93, 94, 95, and 96 of the respective devices constituting the additive manufacturing apparatus 1 in the form of a signal or data of the operation command value.

The laser control device 93 controls the operation of the laser irradiation device 7 based on the operation command. Specifically, the laser control device 93 controls the laser oscillator 72 and outputs the laser beam L at a predetermined laser power and irradiation timing. Further, the laser control device 93 controls the lens actuator and moves the movable lens 73b1, so that the laser beam L is adjusted to a predetermined beam diameter. Further, the laser control device 93 controls the first actuator and the second actuator and rotates the first galvano mirror 73c1 and the second galvano mirror 73c2 to desired angles. Furthermore, the laser control device 93 feeds back the actual operation information of the laser irradiation device 7 to the numerical control device 91.

The recoater head control device 94 controls the recoater head driving mechanism 33 based on the operation command and under the control, the recoater head driving mechanism 33 rotates the motor 33a to reciprocate the recoater head 32 in the horizontal uniaxial direction. Further, the actual operation information of the recoater head 32 is fed back to the numerical control device 91.

The manufacturing table control device 95 controls the manufacturing table driving mechanism 51 based on the operation command and under the control, the manufacturing table driving mechanism 51 rotates a motor (not shown) to move the manufacturing table 5 in the up and down direction. Further, the actual operation information of the manufacturing table 5 is fed back to the numerical control device 91.

The inert gas system control device 96 controls the operation of the inert gas supply device 11 and the fume collector 12 based on the operation command. Further, the actual running information of the inert gas supply/discharge system is fed back to the numerical control device 91.

The data acquiring device 97 acquires data showing the operating state of the additive manufacturing apparatus 1 and data showing the manufacturing position state in which the solidified layer is formed on the material layer 8 by the irradiation of the laser beam L from the measurement devices and outputs the data to the determination device 91c. As the data showing the operating state, at least one of first data showing the irradiation state of the laser beam L, second data showing the inert gas state, and third data showing the formation state of the material layer 8 is measured by each of first to third measurement devices 10, 20, and 30 and is output to the data acquiring device 97. Further, the fourth data showing the manufacturing position state is measured by a fourth measurement device 40 and is output to the data acquiring device 97. Additionally, the first to fourth data acquired by the data acquiring device 97 will be described in detail later.

The determination device 91c monitors the operating state of the additive manufacturing apparatus 1 based on at least one of the first to third data sent from the data acquiring device 97 and monitors the manufacturing state of the solidified layer based on the fourth data. Further, when it is determined that there is an abnormality in the manufacturing state, the factor of the abnormality is identified from the operating state based on at least one of the first to third data. The determination device 91c will be described in detail later.

The storage device 91a stores the CAM data, the numerical control program, the data input from the data acquiring device 97 to the determination device 91c, and the threshold value or the allowable range used at the time of determining the abnormality and identifying the factor by the determination device 91c.

The display device 92 displays the operation command output from the calculation device 91b of the numerical control device 91 and the result of determining the abnormality and identifying the factor by the determination device 91c.

Next, the first to fourth data used to monitor the operating state of the additive manufacturing apparatus 1 and the manufacturing state of the solidified layer and the measurement method thereof will be described.

Regarding the first data showing the irradiation state of the laser beam L, as those that can have a particularly large effect on the manufacturing state, the temperature of the chamber window 21 through which the laser beam L is transmitted, the laser power of the laser beam L, the scanning speed of the laser beam L, the beam diameter of the laser beam L, and the irradiation timing of the laser beam L are exemplified. If the irradiation of the laser beam L deviates from the preferable state, an abnormality in the manufacturing state due to poor melting or sintering of the material powder is likely to occur. Additionally, these illustrated data may be used alone as the first data, or a plurality of these data may be used as the first data. In this embodiment, the temperature T1 of the chamber window 21 is used as the first data.

The laser beam L irradiated from the laser irradiation device 7 irradiates the material layer 8 through the chamber window 21. At this time, a part of the energy of the laser beam L may be absorbed in the chamber window 21 to cause a local temperature rise due to the adhesion of the fume to the chamber window 21, the deterioration of the chamber window 21 (for example, peeling of the coating), the cloudiness caused by poor cleaning, and the like. When the thermal lens effect in which the refractive index or the like changes with the temperature rise occurs, the focus of the laser beam L moves upward from the initial position, that is, a so-called focus shift occurs. As a result, the beam diameter of the laser beam L on the surface of the material layer 8 becomes large and the energy density decreases, which may cause an abnormality in the manufacturing state.

As shown in FIG. 2, the additive manufacturing apparatus 1 according to this embodiment includes the first measurement device 10 for measuring the temperature T1 of the chamber window 21. The first measurement device 10 is, for example, infrared thermography. The first measurement device 10 is provided at an arbitrary position that does not interfere with the laser beam L irradiated from the laser irradiation device 7 or the machining head of the machining device (not shown) that performs machining such as cutting on the solidified layer as necessary in the process of additive manufacturing. The first measurement device 10 may be fixed to a predetermined position or may be provided to be movable by a driving device (not shown). In this embodiment, an accommodation box (not shown) is disposed inside the chamber 2 and the first measurement device 10 and the driving device (not shown) for moving the first measurement device 10 in the chamber 2 are accommodated in the accommodation box. When measuring the temperature T1 of the chamber window 21, the accommodation box is opened and the first measurement device 10 is disposed at a predetermined position in the chamber 2 by the driving device.

The temperature of the surface on the side of the manufacturing space 2e of the chamber window 21 is measured by the first measurement device 10 and the maximum temperature in the region of the surface through which the laser beam L passes is acquired as the first data. Additionally, the measurement of the temperature T1 may be performed at all times during the additive manufacturing or may be performed only when the material layer 8 is being irradiated with the laser beam L.

Additionally, the first measurement device 10 is not limited to the above-described configuration, but is configured to be suitable for a measurement method according to the type of first data. Further, when a plurality of data is used as the first data, a corresponding number of measurement devices is arranged. When the laser power of the laser beam L is used as the first data, for example, a method of acquiring a signal output from an output monitor terminal of the laser oscillator 72 to identify the laser power or a method of receiving a part of the laser beam L using a beam splitter to detect the laser power can be used. When the scanning speed of the laser beam L is used as the first data, for example, a signal can be acquired from the encoders attached to the first actuator and the second actuator to calculate an actual scanning speed. When the beam diameter of the laser beam L is used as the first data, for example, a signal is acquired from the encoders attached to the first actuator and the second actuator to calculate the optical path length of the laser beam L and further a signal is acquired from the encoder attached to the lens actuator to calculate the focal distance of the laser beam L, so that the beam diameter at the time of the actual additive manufacturing can be calculated from the optical path length and the focal distance. Further, the beam diameter at the time of the actual additive manufacturing may be calculated by adding the focus shift information to the above-described beam diameter calculation method. Further, when the irradiation timing of the laser beam L is used as the first data, it is possible to acquire data (ON/OFF data) showing whether or not the laser beam L is irradiated at a predetermined irradiation timing based on a signal (ON/OFF signal) showing whether or not the laser beam L sent from the laser control device 93 to the control input terminal of the laser oscillator 72 will be irradiated and a signal (ON/OFF signal) showing whether or not the laser beam L output from the output monitor terminal of the laser oscillator 72 has been irradiated.

Regarding the second data showing the inert gas state, as those that can have a particularly large effect on the manufacturing state, the fume concentration in the inert gas in the chamber 2, the wind speed of the inert gas in the chamber 2, the oxygen concentration in the inert gas in the chamber 2, the fume concentration in the inert gas discharged from the chamber 2, and the fume concentration in the inert gas returned from the fume collector 12 to the chamber 2 are exemplified. If the inert gas deviates from the preferable state, deterioration of the material powder and an abnormality in the manufacturing state due to poor melting or sintering of the material powder during the irradiation with the laser beam L is likely to occur. Additionally, these illustrated data may be used alone as the second data, or a plurality of these data may be used as the second data. In this embodiment, the fume concentration C in the inert gas in the chamber 2 is used as the second data.

When a large amount of fume generated when the material layer 8 is irradiated with the laser beam L is present on the optical path, the laser beam L is shielded and the energy reaching the manufacturing position is reduced, which may cause an abnormality in the manufacturing state.

As shown in FIG. 2, the additive manufacturing apparatus 1 according to this embodiment includes the second measurement device 20 for measuring the fume concentration C in the inert gas in the chamber 2. The second measurement device 20 includes a suction port 20a which is provided above the manufactured object in the chamber 2 and a dust meter 20b which is disposed outside the chamber 2. The inert gas collected from the suction port 20a is sent to the dust meter 20b through a tube and the fume concentration C is measured. Here, the position of the suction port 20a for collecting the inert gas is preferably provided at a position as close as possible to the optical path and not interfering with the optical path in order to measure the fume concentration C near the optical path of the laser beam L. Additionally, the suction port for collecting the inert gas may be provided at one position or the suction port may be provided at a plurality of positions in the chamber 2 and a corresponding number of dust meters may be introduced for measurement. Further, the measurement of the fume concentration C may be performed at all times during the additive manufacturing, may be performed in the preparation stage before the start of the additive manufacturing, or may be performed only during the irradiation of the laser beam L for the material layer 8.

Additionally, the second measurement device 20 is not limited to the above-described configuration, but is configured to be suitable for a measurement method according to the type of second data. Further, when a plurality of data is used as the second data, a corresponding number of measurement devices are arranged. When the wind speed of the inert gas in the chamber 2 is used as the second data, anemometers can be arranged at one or more positions (for example, the vicinity of the fourth supply port 2c) in the chamber 2 and the inert gas supply system and the wind speed of the inert gas supplied to the chamber 2 can be measured. When the oxygen concentration in the inert gas in the chamber 2 is used as the second data, for example, an oxygen concentration meter can be arranged at one or more positions in the chamber 2 for measurement or an inert gas concentration meter can be disposed to calculate the relative oxygen concentration from the measurement results. When the fume concentration in the inert gas discharged from the chamber 2 is used as the second data, for example, the suction port of the inert gas can be provided in the vicinity of the first discharge port 2d to collect the inert gas and the fume concentration can be measured by the dust meter. Further, when the fume concentration in the inert gas returned from the fume collector 12 to the chamber 2 is used as the second data, for example, the inert gas sent from the duct box 14 to the fourth supply port 2c can be collected and the fume concentration can be measured.

Regarding the third data showing the formation state of the material layer 8, as those that can have a particularly large effect on the manufacturing state, the uniformity of the surface of the material layer 8, the manufactured thickness of the material layer 8, and the load during the operation of the recoater head 32 are exemplified.

If the formation of the material layer 8 deviates from the preferable state, an abnormality in the manufacturing state such as void is likely to occur. Additionally, these illustrated data may be used alone as the third data, or a plurality of these data may be used as the third data. In this embodiment, the uniformity of the surface of the material layer 8 is used as the third data.

As shown in FIG. 2, the additive manufacturing apparatus 1 according to this embodiment includes the third measurement device 30 for measuring the uniformity of the surface of the material layer 8. The third measurement device 30 is, for example, a camera. In this embodiment, a CCD camera 30a and an LED light (not shown) are arranged on the ceiling of the chamber 2 and the surface of the material layer 8 is imaged by the CCD camera 30a while the material layer is illuminated by the LED light to obtain image data. After the image data is appropriate corrected, the image data is subjected to a binarization process to distinguish a position of the surface of the material layer 8 where the material powder is present and a position where the material powder is insufficient and the metal surface of the solidified layer immediately below the material layer is exposed. By the binarization process, the position where the material powder is present is labeled in black and the position where the metal surface is exposed is labeled in white. Then, the number N of the exposed positions on the metal surface labeled in white is used as the third data showing the uniformity of the surface of the material layer 8. Specifically, the binarization process may be performed, for example, in pixel units of image data or cell units in which image data is divided in a grid pattern. The cell is a collection of plurality of pixels. The number N of the exposed positions on the metal surface can be obtained by counting the pixels or cells labeled in white. Further, the number N of the exposed positions on the metal surface may be multiplied by the area of one pixel or the area of one cell and the total area of the exposed positions on the metal surface labeled in white may be used as the third data showing the uniformity of the surface.

The number N of the exposed positions on the metal surface is preferably measured by acquiring the image data whenever forming one material layer 8. The image data may be acquired for the entire surface of the material layer 8 or may be acquired for a specific region of the surface. Further, the imaging region may be appropriately changed in the process of additive manufacturing.

Additionally, the third measurement device 30 is not limited to the above-described configuration, but is configured to be suitable for a measurement method according to the type of third data. Further, the third measurement device 30 may be configured to move, for example, in the X-axis direction parallel to the upper surface of the material layer 8. Further, the third measurement device 30 may be further configured to move, for example, in the Y-axis direction orthogonal to the X-axis direction and parallel to the upper surface of the material layer 8. Further, the third measurement device 30 may be further configured to move, for example, in the Z-axis direction perpendicular to the upper surface of the material layer 8. The third measurement device 30 may be attached to the machining head of the machining device when the additive manufacturing apparatus 1 includes the machining device.

Further, when a plurality of data is used as the third data, a corresponding number of measurement devices are arranged. When the manufactured thickness of the material layer is used as the third data, for example, the thickness can be calculated by detecting the positions of the surfaces before and after the formation of the material layer using a two-dimensional laser displacement meter and taking the difference. Further, when the load at the time of operating the recoater head 32 is used as the third data, for example, the current value flowing through the motor 33a of the recoater head driving mechanism 33 or the pressure value generated between the recoater head 32 and the recoater head driving mechanism 33 can be measured.

When the material layer 8 is irradiated with the laser beam L to form the solidified layer, protrusions may be formed on the surface of the solidified layer due to the influence of the focus shift of the laser beam L, the influence of the fume floating on the optical path of the laser beam L in the chamber, and the like. The uniformity of the surface of the material layer 8 may decrease if the large protrusions formed on the surface of the solidified layer contact the blades 32fb and 32rb when the recoater head 32 supplies material powder onto the solidified layer while moving above the solidified layer and forms the material layer 8 having a predetermined thickness on the solidified layer by flattening the material powder using the blades 32fb and 32rb of the recoater head 32. If the large protrusions formed on the surface of the solidified layer contact the blades 32fb and 32rb of the recoater head 32, the load at the time of operating the recoater head 32 becomes larger than the case of the non-contact state. Accordingly, the current value or the pressure value measured in this way can be used as the third data showing the formation state of the material layer 8.

Regarding the fourth data showing the manufacturing position state, the temperature of the molten pool formed at the manufacturing position, the appearance properties of the irradiation spot formed at the manufacturing position during the irradiation with the laser beam L, the image data of the appearance properties of the spatter generated during the irradiation with the laser beam L, and the depth of the keyhole formed at the manufacturing position are exemplified. When the manufacturing position state deviates from the preferable state, poor formation of solidified layer is likely to occur. Thus, it is possible to suppress defects caused by an abnormality in the manufacturing state by monitoring the fourth data. Additionally, these illustrated data may be used alone as the fourth data, or a plurality of these data may be used as the fourth data. In this embodiment, the temperature T4 of the molten pool formed at the manufacturing position is used as the fourth data.

When the material layer 8 is irradiated with the laser beam L, the material powder at the irradiated position is melted to form a molten pool. The temperature T4 of the molten pool has an appropriate range according to the conditions such as material powder and when the temperature exceeds the range (excessive melting) or falls below the range (insufficient melting), poor formation of the solidified layer is likely to occur.

As shown in FIG. 2, the additive manufacturing apparatus 1 according to this embodiment includes the fourth measurement device 40 for measuring the temperature T4 of the molten pool. As the fourth measurement device 40, for example, a temperature measurement device based on a two-color method can be used. In this embodiment, a two-color temperature measurement device is introduced as the fourth measurement device 40 and light generated when the material layer 8 is irradiated with the laser beam L to melt the material powder and form the molten pool is input to a photosensor (not shown) called a photodiode or photodetector via the galvano unit 73 so that the temperature T4 of the molten pool is detected. At this time, the galvano unit 73 is provided with an optical element constituting a part of the fourth measurement device such as a beam splitter (not shown) provided between the collimator 73a and the focus control unit 73b so as to transmit the laser beam L and reflect the light generated from the molten pool toward the outside of the galvano unit 73. The fourth measurement device 40 splits the light of the molten pool reflected by the beam splitter in the galvano unit 73 into two by another beam splitter (not shown). In the light of the molten pool spitted into two, one of them is input to the first photosensor via a first bandpass filter and the other of them is input to a second photosensor via a second bandpass filter. The first bandpass filter and the second bandpass filter each transmit only light of a predetermined wavelength. In another embodiment (not shown), radiation at two different wavelengths when the molten pool to be measured is irradiated with a laser beam for temperature measurement (not shown) of a predetermined wavelength from above is detected and the temperature T4 of the molten pool is calculated based on the strength. Additionally, the temperature T4 is preferably measured in real time while the laser beam L is irradiated and the molten pool is formed.

Additionally, the fourth measurement device 40 is not limited to the above-described configuration, but is configured to be suitable for a measurement method according to the type of fourth data. Further, when a plurality of data is used as the fourth data, a corresponding number of measurement devices are arranged. When the image data of the appearance properties of the spatter generated when the laser beam L is irradiated is used as the fourth data, for example, a camera can be disposed on the ceiling of the chamber 2 to image the spatter generated around the molten pool during irradiation.

Next, the monitoring of the operating state of the additive manufacturing apparatus 1, the monitoring of the manufacturing state of the solidified layer, and the identifying of the factor of the abnormality in the manufacturing state by the determination device 91c according to this embodiment will be described.

The first to fourth data which can be obtained by the measurement using the first to fourth measurement devices 10, 20, 30, and 40 are acquired by the data acquiring device 97 and are sent to the determination device 91c. The determination device 91c monitors the operating state of the additive manufacturing apparatus 1 based on the first to third data. At this time, a predetermined threshold value or a predetermined allowable range relating to the first to third data stored in the storage device 91a is used. The threshold value or the allowable range can be determined by, for example, test manufacturing performed as a preliminary survey of the additive manufacturing depending on various conditions necessary for the additive manufacturing such as the type of material powder and laser irradiation conditions.

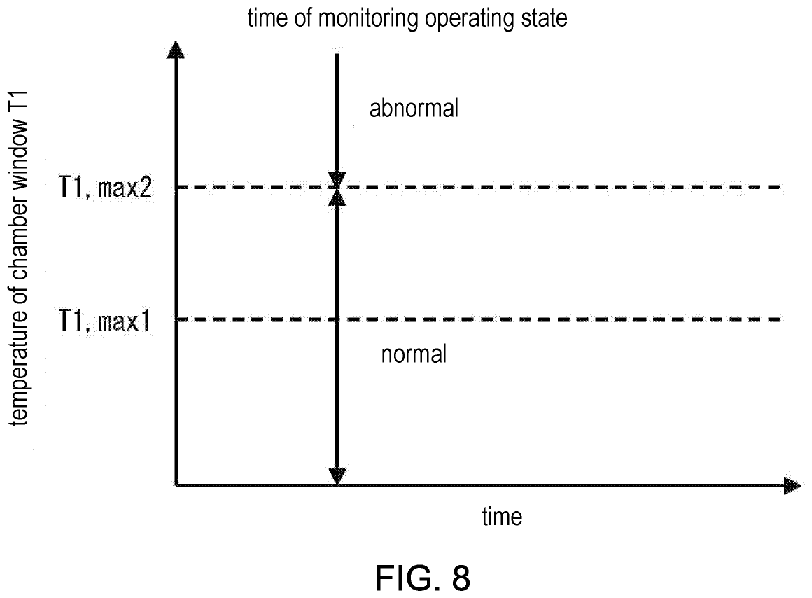

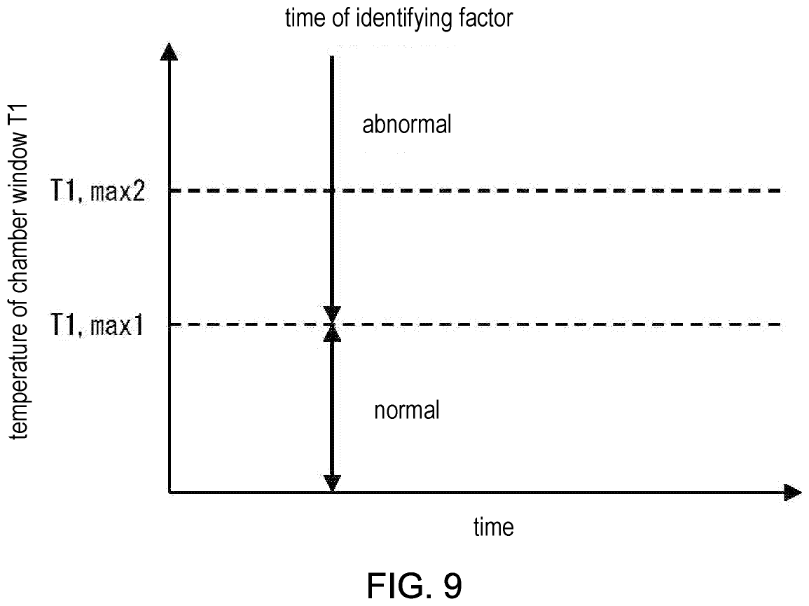

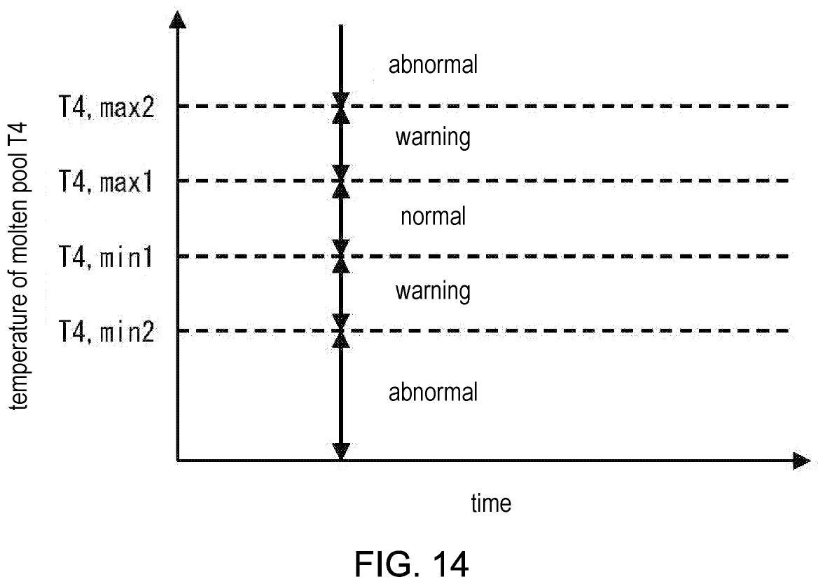

FIGS. 8 and 9 are diagrams illustrating the allowable range of the first data according to this embodiment. The focus shift is less likely to occur as the temperature T1 of the chamber window 21 becomes lower, which is preferable as the irradiation state of the laser beam L. Thus, at least the upper limit value corresponding to the allowable range of the temperature T1 may be stored in the storage device 91a as a threshold value. Here, the upper limit value is set in two stages. Specifically, the first upper limit value T1, max1 and the second upper limit value T1, max2 are respectively set to predetermined values so as to satisfy the relationship of T1, max1<T1, max2 and are stored. When the determination device 91c compares the upper limit value with the temperature T1, the first upper limit value T1, max1 becomes a stricter upper limit value than the second upper limit value T1, max2. The second upper limit value T1, max2 is, for example, the upper limit value usually used in monitoring the operating state. Here, FIGS. 8, 9, and 14 are shown on the same time axis since the temperature T1 of the chamber window 21 shown in FIGS. 8 and 9 and the temperature T4 of the molten pool shown in FIG. 14 to be described later are acquired at the same timing.

When the temperature T1 of the chamber window 21 is sent from the data acquiring device 97 to the determination device 91c as the first data, the determination device 91c compares the temperature T1 with the upper limit value stored in the storage device 91a to monitor the operating state. As shown in FIG. 8, the upper limit value used here is the second upper limit value T1, max2 of two stages. The second upper limit value T1, max2 is, for example, the upper limit value usually used in monitoring the operating state. When the temperature T1 satisfies the relationship of T1≤T1, max2 (normal value), the determination device 91c determines that there is no abnormality in the irradiation state of the laser beam L. On the other hand, when the temperature T1 satisfies the relationship of T1, max2<T1 (abnormal value), the determination device 91c determines that there is an abnormality in the irradiation state of the laser beam L regardless of the monitoring of the manufacturing state to be described later.

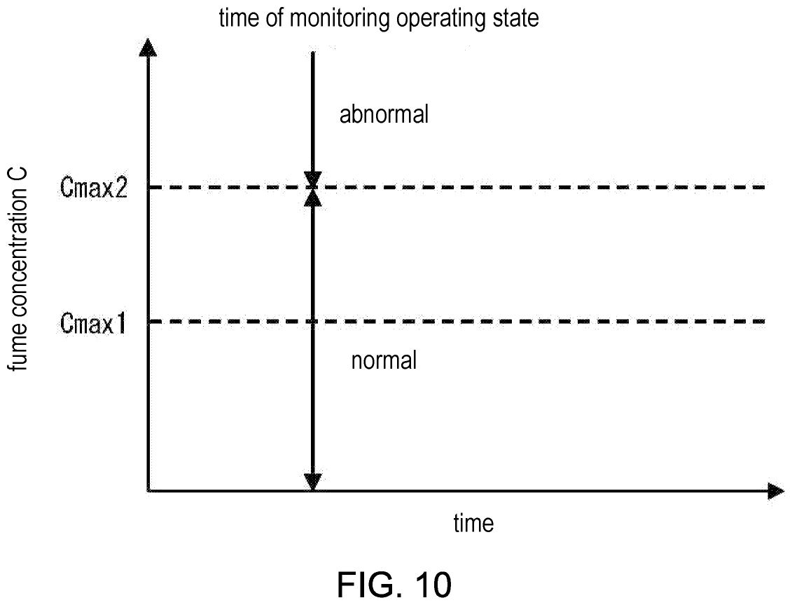

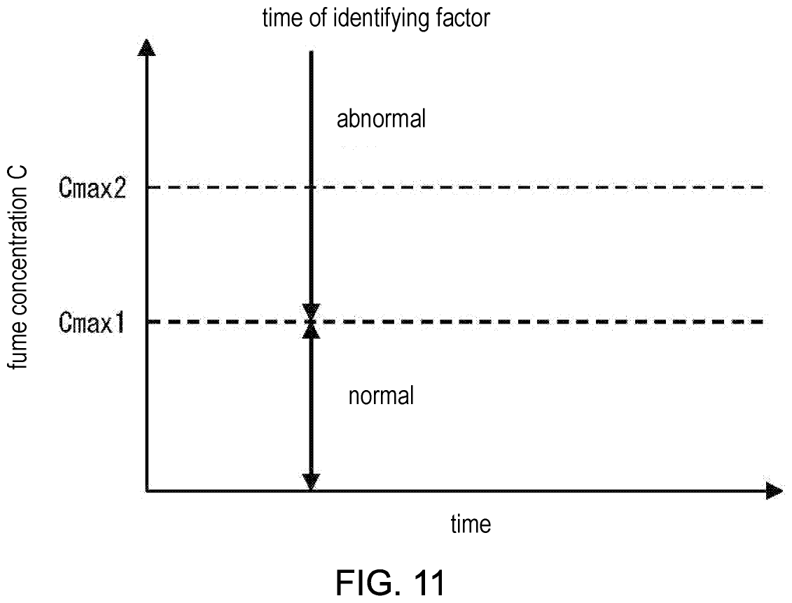

FIGS. 10 and 11 are diagrams illustrating the allowable range of the second data according to this embodiment. The shielding of the laser beam L is less likely to occur as the fume concentration C in the inert gas in the chamber 2 becomes lower, which is preferable as the inert gas state. Thus, at least the upper limit value corresponding to the allowable range of the fume concentration C may be stored in the storage device 91a as a threshold value. Here, the upper limit value is set in two stages. Specifically, the first upper limit value Cmax1 and the second upper limit value Cmax2 are respectively set to predetermined values so as to satisfy the relationship of Cmax1<Cmax2 and stored. When the determination device 91c compares the upper limit value with the fume concentration C, the first upper limit value Cmax1 becomes a stricter upper limit value than the second upper limit value Cmax2. The second upper limit value Cmax2 is, for example, the upper limit value usually used in monitoring the operating state. Here, FIGS. 10, 11, and 14 are shown on the same time axis since the fume concentration C in the inert gas shown in FIGS. 10 and 11 and the temperature T4 of the molten pool shown in FIG. 14 to be described later are acquired at the same timing.

When the fume concentration C in the inert gas in the chamber 2 is sent from the data acquiring device 97 to the determination device 91c as the second data, the determination device 91c compares the fume concentration C with the upper limit value stored in the storage device 91a to monitor the operating state. As shown in FIG. 10, the upper limit value used here is the second upper limit value Cmax2 of two stages. The second upper limit value Cmax2 is, for example, the upper limit value usually used in monitoring the operating state. When the fume concentration C satisfies the relationship of C≤Cmax2 (normal value), the determination device 91c determines that there is no abnormality in the inert gas state. On the other hand, when the fume concentration C satisfies the relationship of Cmax2<C (abnormal value), the determination device 91c determines that there is an abnormality in the inert gas state regardless of the monitoring of the manufacturing state to be described later.

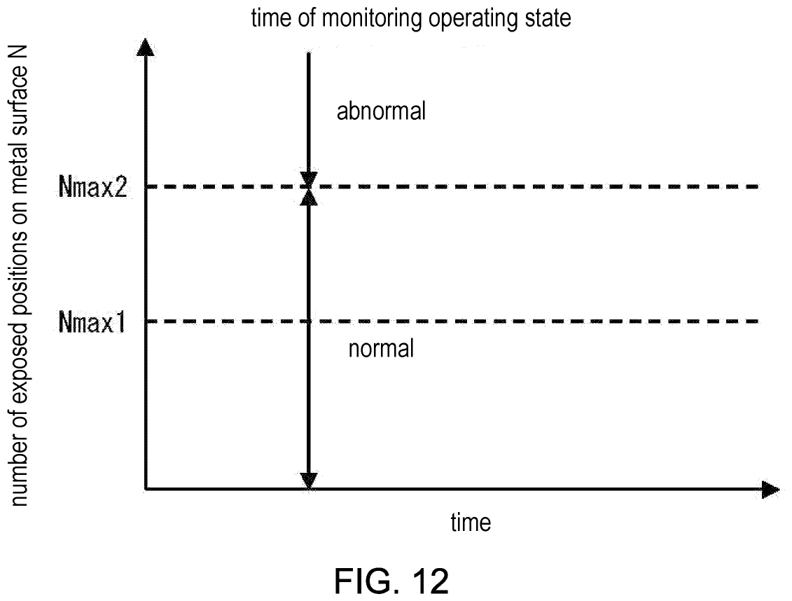

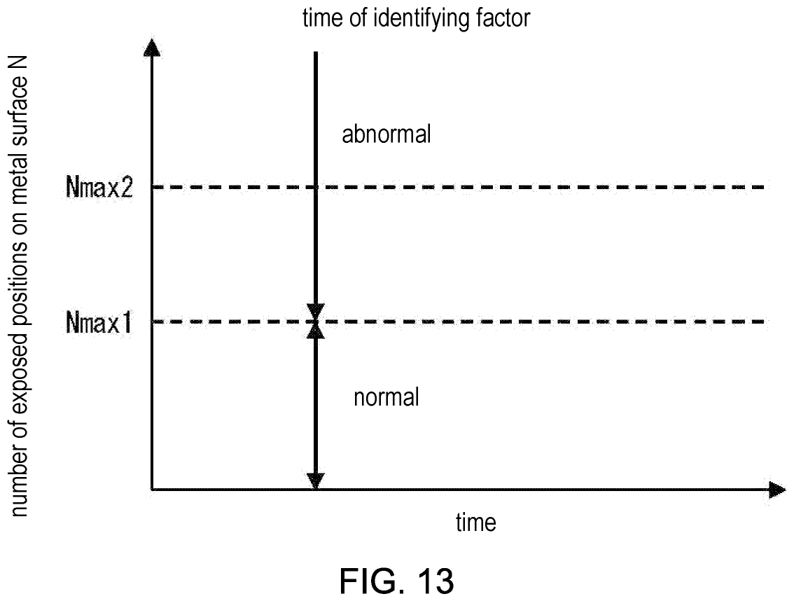

FIGS. 12 and 13 are diagrams illustrating the allowable range of the third data according to this embodiment. The uniformity of the surface of the material layer 8 is preferable as the formation state of the material layer 8 as the number N of the exposed positions on the metal surface becomes smaller. Thus, at least the upper limit value corresponding to the allowable range of the number N of the exposed positions on the metal surface may be stored in the storage device 91a as a threshold value. Here, the upper limit value is set in two stages. Specifically, the first upper limit value Nmax1 and the second upper limit value Nmax2 are respectively set to predetermined values so as to satisfy the relationship of Nmax1<Nmax2 and stored. When the determination device 91c compares the upper limit value with the number N of the exposed positions on the metal surface, the first upper limit value Nmax1 becomes a stricter upper limit value than the second upper limit value Nmax2. The second upper limit value Nmax2 is, for example, the upper limit value usually used in monitoring the operating state. Here, FIGS. 12 and 13 are shown on the time axis different from the temperature T4 of the molten pool shown in FIG. 14 to be described later since the number N of the exposed positions on the metal surface is acquired before the formation of the solidified layer starts.

When the number N of the exposed positions on the metal surface is sent from the data acquiring device 97 to the determination device 91c as the third data, the determination device 91c compares the number N of the exposed positions on the metal surface with the upper limit value stored in the storage device 91a to monitor the operating state. As shown in FIG. 12, the upper limit value used here is the second upper limit value Nmax2 of two stages. The second upper limit value Nmax2 is, for example, the upper limit value usually used in monitoring the operating state. When the number N of the exposed positions on the metal surface satisfies the relationship of N≤Nmax2 (normal value), the determination device 91c determines that there is no abnormality in the formation state of the material layer 8. On the other hand, when the number N of the exposed positions on the metal surface satisfies the relationship of Nmax2<N (abnormal value), the determination device 91c determines that there is an abnormality in the formation state of the material layer 8 regardless of the monitoring of the manufacturing state to be described later.

The determination result of the abnormality in each operating state of the additive manufacturing apparatus 1 is displayed on the display device 92 and is sent to the calculation device 91b of the numerical control device 91.

The determination device 91c monitors the manufacturing state of the solidified layer based on the fourth data in parallel with the monitoring of the operating state. At this time, the predetermined threshold value or the allowable range relating to the fourth data stored in the storage device 91a is used. The threshold value or the allowable range can be determined by, for example, test manufacturing performed as a preliminary survey of the additive manufacturing depending on various conditions necessary for the additive manufacturing such as the type of material powder and laser irradiation conditions.

FIG. 14 is a diagram illustrating the allowable range of the fourth data of the embodiment. If the temperature T4 of the molten pool is too high or too low, poor formation of the solidified layer is likely to occur. Thus, the upper limit value and the lower limit value corresponding to the allowable range of the temperature T4 are stored in the storage device 91a. Here, each of the upper limit value and the lower limit value may be set to one or may be set in two stages. In this embodiment, the upper limit value is set and stored so that the first upper limit value T4, max1 and the second upper limit value T4, max2 satisfy the relationship of T4, max1<T4, max2 and the lower limit value is set and stored so that the first lower limit value T4, min1 and the second lower limit value T4, min2 satisfy the relationship of T4, min1>T4, min2. As the first upper limit value T4, max1 and the first lower limit value T4, min1 in such two stages, for example, the upper limit value and the lower limit value can be set such that the temperature T4 of the molten pool is appropriate in the case of T4, min1≤T4≤T4, max1 and can be regarded as sufficiently low in the possibility that the solidified layer is poorly formed even if the manufacturing is continued in this state. As the second upper limit value T4, max2 and the second lower limit value T4, min2, for example, the upper limit value and the lower limit value can be set such that the temperature T4 of the molten pool is not appropriate in the case of T4<T4, min2 or T4, max2<T4 and can be regarded as sufficiently high in the possibility that the solidified layer is poorly formed.

When the temperature T4 satisfies the relationship of T4, min1≤T4≤T4, max1 (normal value), the determination device 91c determines that there is no abnormality in the manufacturing state. Further, when the temperature T4 satisfies the relationship of T4<T4, min2 or T4, max2<T4 (abnormal value), the determination device 91c determines that there is an abnormality in the manufacturing state.

When the upper limit value and the lower limit value are set as described above, in the case of T4, min2≤T4<T4, min1 (warning range) or T4, max1<T4≤T4, max2 (warning range), the temperature T4 of the molten pool at the time point of acquiring the temperature T4 of the molten pool is appropriate and poor formation of the solidified layer does not occur at the acquired time point. However, when the manufacturing is continued in this state, there is a possibility that poor formation of the solidified layer is likely to occur. Various modes can be considered for determining whether there is an abnormality in the manufacturing state in such a case according to the quality control policy, and the determination device 91c can be appropriately configured accordingly. For example, in order to perform more reliable quality control on the additive manufactured object, the determination device 91c may be configured to determine that there is an abnormality in the manufacturing state even when the temperature T4 is in the warning range. Alternatively, the determination device 91c may be configured to determine that there is an abnormality in the manufacturing state when the temperature T4 acquired in time series is in the warning range for a plurality of times continuously or for a predetermined time. Alternatively, the determination device 91c may be configured to determine that there is no abnormality in the manufacturing state in the warning range and display the warning on the display device 92 together with the determination result. Alternatively, when two or more of the above-exemplified data are used as the fourth data, the determination device 91c may be configured to determine that there is no abnormality in the manufacturing state when only one of the fourth data is in the warning range and the other is in the normal range and may be configured to determine that there is an abnormality in the manufacturing state when a plurality of data in the fourth data are in the warning range and the other is in the normal range.

Based on the results obtained by identifying the factor of the abnormality in the manufacturing state, a protective glass may be replaced, for example, by an operation after one solidified layer is formed. When the determination device 91c is configured to determine that there is an abnormality in the manufacturing state even when the temperature T4 is in the warning range, it is possible to completely form the solidified layer before the temperature T4 enters the abnormal range even when the temperature T4 is in the warning range during the formation of the solidified layer. Further, based on the results obtained by identifying the factor of the abnormality in the manufacturing state to be described later, the warning range can be omitted, for example, when the operation command value or the like can be corrected during the formation of the solidified layer.

The determination result of the abnormality in the manufacturing state of the solidified layer is displayed on the display device 92 and is sent to the calculation device 91b of the numerical control device 91.

When the determination device 91c determines that there is an abnormality in the manufacturing state, the factor of the abnormality is identified from the operating state of the additive manufacturing apparatus 1 based on at least one of the first to third data. In this embodiment, the factor is identified based on all of the first to third data.

The determination device 91c determines whether or not the irradiation state of the laser beam L can cause an abnormality in the manufacturing state based on the first data. At this time, the temperature T1 of the chamber window 21 is compared with the upper limit value stored in the storage device 91a and as shown in FIG. 9, the first upper limit value T1, max1 which is a stricter upper limit value of two stages is used. When the temperature T1 satisfies the relationship of T1≤T1, max1 (normal value), the possibility that the temperature T1 of the chamber window 21 causes the abnormality in the manufacturing state is low and the determination device 91c determines that there is no abnormality in the irradiation state of the laser beam L. On the other hand, when the temperature T1 satisfies the relationship of T1, max1<T1 (abnormal value), the possibility that the temperature T1 of the chamber window 21 contributes to the abnormality in the manufacturing state is high and the determination device 91c determines that there is an abnormality in the irradiation state of the laser beam L.

Further, the determination device 91c determines whether or not the inert gas state causes the abnormality in the manufacturing state based on the second data. At this time, the fume concentration C in the inert gas is compared with the upper limit value stored in the storage device 91a and as shown in FIG. 11, the first upper limit value Cmax1 which is a stricter upper limit value of two stages is used. When the fume concentration C satisfies the relationship of C≤Cmax1 (normal value), the possibility that the fume concentration C in the inert gas causes the abnormality in the manufacturing state is low and the determination device 91c determines that there is no abnormality in the inert gas state. On the other hand, when the fume concentration C satisfies the relationship of Cmax1<C (abnormal value), the possibility that the fume concentration C in the inert gas contributes to the abnormality in the manufacturing state is high and the determination device 91c determines that there is an abnormality in the inert gas state.

Further, the determination device 91c determines whether or not the formation state of the material layer 8 causes the abnormality in the manufacturing state based on the third data. At this time, the number N of the exposed positions on the metal surface is compared with the upper limit value stored in the storage device 91a and as shown in FIG. 13, the first upper limit value Nmax1 which is a stricter upper limit value of two stages is used. When the number N of the exposed positions on the metal surface satisfies the relationship of N Nmax1 (normal value), the possibility that the uniformity of the surface causes the abnormality in the manufacturing state is low and the determination device 91c determines that there is no abnormality in the formation state of the material layer 8. On the other hand, when the number N of the exposed positions on the metal surface satisfies the relationship of Nmax1<N (abnormal value), the possibility that the uniformity of the surface contributes to the abnormality in the manufacturing state is high and the determination device 91c determines that there is an abnormality in the formation state of the material layer 8.

The operating state determined to have an abnormality is displayed on the display device 92 as having a high possibility of causing the abnormality in the manufacturing state and the determination result is sent to the calculation device 91b of the numerical control device 91.

As described above, the determination device 91c according to this embodiment determines whether or not there is an abnormality in the operating state by comparison with the first to third data using the threshold value or the allowable range usually used among the threshold values or the allowable ranges set in two stages at the time of monitoring the operating state. Further, the manufacturing state is monitored based on the fourth data in parallel with the monitoring of the operating state. When it is determined that there is an abnormality in the manufacturing state, the first to third data are compared by using a stricter one among the threshold values or the allowable ranges set in two stages, the presence or absence of the abnormality in the operating state is determined from the viewpoint as the factor of the abnormality in the manufacturing state, and the operating state having high possibility is identified.

In the process of additive manufacturing, the abnormality in the manufacturing state may occur or the degree of abnormality may increase due to the combination of changes in each operating state. For example, a focus shift occurs since the beam diameter of the laser beam L increases as the temperature of the chamber window 21 increases, laser power decreases since the laser beam L is shielded by a part of the fume in the inert gas in the chamber 2, and the energy density of the laser beam L irradiating the surface of the material layer 8 decreases, so that the energy density is insufficient and poor melting or sintering may occur. That is, even if the change is small and can be regarded as normal focusing on each operating state (in the above-described example, the temperature T1 of the chamber window 21 and the fume concentration C in the inert gas), there is a possibility that the changes are combined and hence the abnormality in the manufacturing state occurs.

In the control based on only the monitoring of the operating state, the above-described situation can be avoided by making the threshold value or the allowable range used for determining the abnormality in each operating state more strict. On the other hand, when the threshold value or the allowable range is too strict, events in which the operating state is determined to be abnormal occur frequently even though the abnormal manufacturing state has not actually occurred. Accordingly, there is a risk that the production efficiency will decrease due to interruption of additive manufacturing to deal with the abnormality.

In the additive manufacturing apparatus 1 according to this embodiment, the manufacturing state is monitored in parallel with the monitoring of the operating state. Accordingly, it is possible to detect the abnormality in the manufacturing state that occurs when the changes are combined in addition to the abnormality in the manufacturing state that occurs due to changes in each operating state as the sole factor. In this way, it is possible to more reliably suppress the occurrence of defective products since it is possible to detect the abnormality actually occurring in the manufacturing state and it is possible to avoid a decrease in production efficiency since it is not necessary to set the threshold value or the allowable range used for determining the abnormality in the monitoring of the operating state more strictly than necessary.

Further, in the additive manufacturing apparatus 1 according to this embodiment, when it is determined that there is an abnormality in the manufacturing state, the factor of the abnormality is identified based on the data relating to the operating state. Accordingly, since trial and error in identifying factors is reduced, it is possible to take appropriate measures at an early stage. At this time, when comparison is performed by using the threshold value or the allowable range which is stricter than the threshold value or the allowable range used for monitoring the operating state, it is possible to examine the factor of the abnormality in the manufacturing state by taking into consideration of the case where the abnormality occurs due to the combination of changes in the operating state.

Additionally, the modes of the monitoring of the operating state of the additive manufacturing apparatus 1, the monitoring of the manufacturing state of the solidified layer, and the identifying of the factor of the manufacturing state using the determination device 91c are not limited to the above-described embodiment and various modifications are supposed. In the above-described embodiment, the determination device 91c compared the threshold value or the allowable range by directly using the first to fourth data acquired by the respective measurement devices. The configuration of the determination device 91c is not limited thereto. For example, the determination device 91c may be configured to process data such as calculating other data from the data using a predetermined mathematical formula as necessary and to compare the calculated data with the threshold value or the allowable range. For example, when the laser power of the laser beam L, the scanning speed of the laser beam L, and the beam diameter of the laser beam L are acquired as the first data, the energy density of the laser beam L of the surface of the material layer 8 may be calculated from these data and the calculated energy density may be compared with the threshold value or the allowable range stored in the storage device 91a to determine whether or not there is an abnormality in the irradiation state of the laser beam L.

Further, for example, when the data acquiring device 97 acquires the first data, the determination device 91c determines whether or not there is an abnormality in the manufacturing state by comparison with a predetermined threshold value or a predetermined allowable range based on the fourth data in real time during the irradiation of the laser beam L. When it is determined that there is an abnormality in the manufacturing state, the determination device further determines whether or not there is an abnormality in the irradiation state of the laser beam L by comparison with a predetermined threshold value or a predetermined allowable range based on the first data.

Further, for example, when the data acquiring device 97 acquires the second data, the determination device 91c determines whether or not there is an abnormality in the manufacturing state by comparison with a predetermined threshold value or a predetermined allowable range based on the fourth data in real time during the irradiation of the laser beam L. When it is determined that there is an abnormality in the manufacturing state, the determination device further determines whether or not there is an abnormality in the inert gas state by comparison with a predetermined threshold value or a predetermined allowable range based on the second data.

Further, for example, when the data acquiring device 97 acquires the third data, the determination device 91c determines whether or not there is an abnormality in the manufacturing state by comparison with a predetermined threshold value or a predetermined allowable range based on the fourth data in real time during the irradiation of the laser beam L. When it is determined that there is an abnormality in the manufacturing state, the determination device further determines whether or not there is an abnormality in the formation state of the material layer 8 by comparison with a predetermined threshold value or a predetermined allowable range based on the third data.

Further, for example, the additive manufacturing apparatus 1 may identify the factor of the abnormality in the manufacturing state of the solidified layer by the determination device 91c and perform at least one of a stop operation, a predetermined operation, a repeating operation, a setting correction, and an operation command value correction based on the factor.

Further, for example, the correction of the operation command value may be performed in real time during the operation of the additive manufacturing apparatus 1 based on at least one of the first to third data.

Next, a method of producing an additive manufactured object using the additive manufacturing apparatus 1 according to this embodiment will be described.

A method of producing an additive manufactured object using the additive manufacturing apparatus 1 according to this embodiment includes at least a material layer forming step, a solidified layer forming step, a data acquiring step, and a determination step. In the material layer forming step, the material layer 8 is formed by supplying material powder onto the manufacturing region R by the recoater head 32 in the chamber 2 which covers the manufacturing region R, has the chamber window 21 provided on the ceiling, and is filled with an inert gas having a predetermined concentration. In the solidified layer forming step, the solidified layer is formed by irradiating the manufacturing position of the material layer 8 with the laser beam L through the chamber window 21. In the data acquiring step, at least one of first data showing the irradiation state of the laser beam L, second data showing the inert gas state, and third data showing the formation state of the material layer 8 and fourth data showing the manufacturing position state are acquired by measurement. In the determination step, it is determined whether or not there is an abnormality in the manufacturing state of the solidified layer based on the fourth data and when it is determined that there is an abnormality in the manufacturing state, the factor of the abnormality in the manufacturing state of the solidified layer is identified from the operating state of the additive manufacturing apparatus 1 based on at least one of the acquired first to third data.

Further, for example, when the first data is acquired by the data acquiring step, in the determination step, it is determined whether or not there is an abnormality in the manufacturing state by comparison with a predetermined threshold value or a predetermined allowable range based on the fourth data in real time during the irradiation of the laser beam L and when it is determined that there is an abnormality in the manufacturing state, the determination device further determines whether or not there is an abnormality in the irradiation state of the laser beam L by comparison with a predetermined threshold value or a predetermined allowable range based on the first data.

Further, for example, when the second data is acquired by the data acquiring step, in the determination step, it is determined whether or not there is an abnormality in the manufacturing state by comparison with a predetermined threshold value or a predetermined allowable range based on the fourth data in real time during the irradiation of the laser beam L and when it is determined that there is an abnormality in the manufacturing state, the determination device further determines whether or not there is an abnormality in the inert gas state by comparison with a predetermined threshold value or a predetermined allowable range based on the second data.

Further, for example, when the third data is acquired by the data acquiring step, in the determination step, it is determined whether or not there is an abnormality in the manufacturing state by comparison with a predetermined threshold value or a predetermined allowable range based on the fourth data in real time during the irradiation of the laser beam L and when it is determined that there is an abnormality in the manufacturing state, the determination device further determines whether or not there is an abnormality in the formation state of the material layer 8 by comparison with a predetermined threshold value or a predetermined allowable range based on the third data.

Further, for example, the additive manufacturing apparatus 1 identifies the factor of the abnormality in the manufacturing state of the solidified layer by the determination step and performs at least one of a stop operation, a predetermined operation, a repeating operation, a setting correction, and an operation command value correction based on the factor.

The method of producing the additive manufactured object using the additive manufacturing apparatus 1 according to this embodiment will be described in more detail.

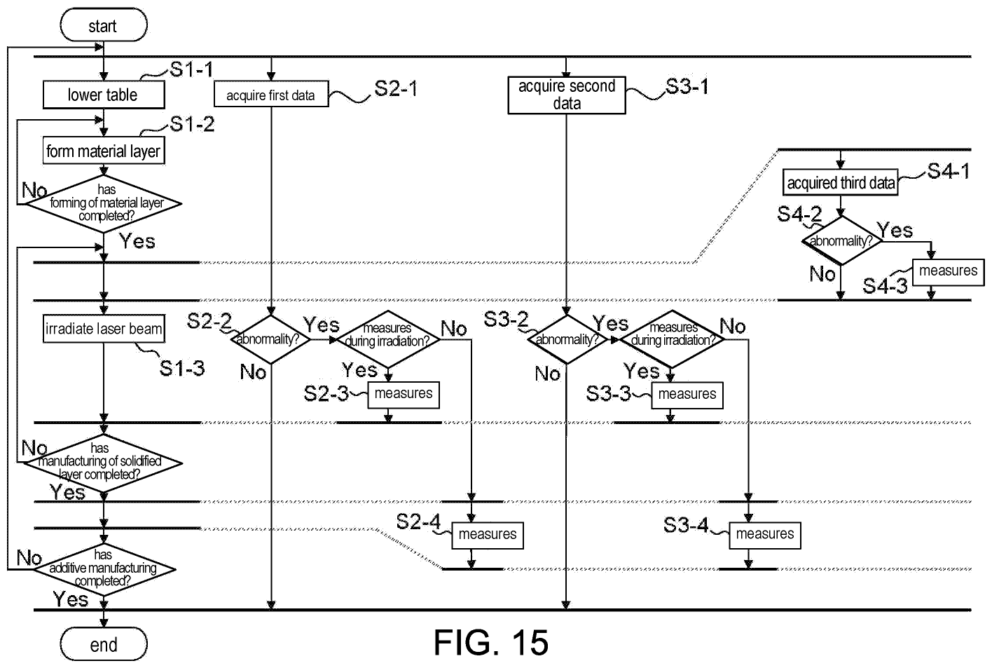

As shown in FIG. 15, the operating state is monitored based on the first to third data in parallel with the production of the additive manufactured object. When the additive manufacturing apparatus 1 starts the additive manufacturing, the manufacturing table 5 on which the base plate 6 is placed is lowered and adjusted to an appropriate position (step S1-1). In this state, the material layer 8 is formed by allowing the recoater head 32 to wait on the left side of the manufacturing region R again as shown in FIG. 2 after moving the recoater head 32 waiting on the right side of the manufacturing region R from the right side to the left side of the manufacturing region R in the direction indicated by an arrow H as shown in FIG. 1 (step S1-2). Further, the material layer 8 is solidified by irradiating a predetermined position of the material layer 8 with the laser beam L (step S1-3). Here, step S1-2 is the above-described material layer forming step. step S1-1 may be included in the above-described material layer forming step. step S1-3 is the above-described solidified layer forming step.

The operating state of the additive manufacturing apparatus 1 is monitored in parallel with the production of the additive manufactured object. The first measurement device 10 measures the temperature T1 of the chamber window 21 relating to the first data while producing the additive manufactured object. Alternatively, the first measurement device 10 may measure the temperature T1 of the chamber window 21 relating to the first data in parallel with step S1-3 (not shown). The data acquiring device 97 acquires the first data in real time (step S2-1). The first data is sent to the determination device 91c and the determination device 91c compares the temperature T1 with the second upper limit value T1, max2 and determines whether or not there is an abnormality in the irradiation state of the laser beam L (step S2-2). Here, step S2-1 is the above-described data acquiring step.

When it is determined that there is an abnormality in the irradiation state of the laser beam L, measures to resolve the abnormality are performed (steps S2-3 and S2-4). The measures include, for example, the measures taken during the irradiation of the laser beam L (step S2-3) and the measures taken after the manufacturing of one solidified layer is completed (step S2-4). As the corresponding measures, for example, the focal position can be corrected by moving the movable lens 73b1 of the laser irradiation device 7 in response to the degree of the focus shift due to the thermal lens effect during the irradiation of the laser beam L (step S2-3). Further, for example, it is possible to temporarily stop the manufacturing when the manufacturing of one solidified layer is completed and replace the chamber window 21 in which the thermal lens effect is generated due to the adhesion of fume or the like (step S2-4).

At the same time as the start of the additive manufacturing, the second measurement device 20 starts the measurement of the fume concentration C in the inert gas in the chamber 2 relating to the second data. The data acquiring device 97 acquires the second data in real time (step S3-1). The second data is sent to the determination device 91c and the determination device 91c compares the fume concentration C with the second upper limit value Cmax2 to determine whether or not there is an abnormality in the inert gas state (step S3-2). Here, step S3-1 is the above-described data acquiring step.

When it is determined that there is an abnormality in the inert gas state, measures to resolve the abnormality are performed (steps S3-3 and S3-4). The measures include, for example, the measures taken during the irradiation of the laser beam L (step S3-3) and the measures taken after the manufacturing of one solidified layer is completed (step S3-4). As the corresponding measures, the followings are performed to reduce the fume concentration C in the inert gas in the chamber 2. For example, a region in which one solidified layer is formed by irradiating the material layer 8 with the laser beam L is divided into a plurality of regions and the irradiation of the laser beam L is temporarily suspended for a predetermined time between the irradiation of the laser beam L on one divided region and the irradiation of the laser beam L on the next divided region while the divided regions are sequentially irradiated with the laser beam L (step S3-3). Further, for example, when a plurality of filters of the dust collector used as the fume collector 12 is provided, the filters are automatically switched during the irradiation of the laser beam L (step S3-3). Further, for example, since the energy of the laser beam L reaching the surface of the material layer 8 decreases due to an increase in the fume concentration C, it is also possible to adjust the output setting of the laser beam L during the irradiation of the laser beam L in order to compensate for this decrease (step S3-3). Further, for example, when the manufacturing of one solidified layer is completed, the filter of the dust collector used as the fume collector 12 is replaced (step S3-4). Further, for example, when a plurality of the fume collectors 12 is provided, it is possible to switch the fume collectors when the manufacturing of one solidified layer is completed (step S3-4).

After the formation of the material layer 8 is completed by step S1-2, the third measurement device 30 measures the number N of the exposed positions on the metal surface of the surface of the material layer 8 relating to the third data. The data acquiring device 97 acquires the third data (step S4-1). The third data is sent to the determination device 91c and the determination device 91c compares the number N of the exposed positions on the metal surface with the second upper limit value Nmax2 to determine whether or not there is an abnormality in the formation state of the material layer 8 (step S4-2). Here, step S4-1 is the above-described data acquiring step.

When it is determined that there is an abnormality in the formation state of the material layer 8, measures to resolve the abnormality are performed (step S4-3). The measures are taken, for example, after the formation of the material layer 8 is completed (S4-3). As the corresponding measures, the material layer 8 can be formed again by moving the recoater head 32 again after performing a predetermined operation to suppress the recurrence of the defective formation state of the material layer 8 (step S4-3). As the predetermined operation, for example, when the fluidity of the material powder is reduced due to absorption of moisture or the like and the supply from the material discharge port 32c is stagnant, the recoater head 32 is promptly moved forward and backward in the direction indicated by an arrow H to be vibrated. Accordingly, it is possible to eliminate the aggregation or clogging of the material powder in the material storage member 32a and promote the discharge. Further, as the predetermined operation, for example, when the material layer of the second and subsequent layers is formed, if the material layer is non-uniform due to the presence of protrusions or the like on the surface of the solidified layer directly under the material layer, it is possible to cut the protrusions and the like with a machining device that performs machining by cutting the solidified layer.

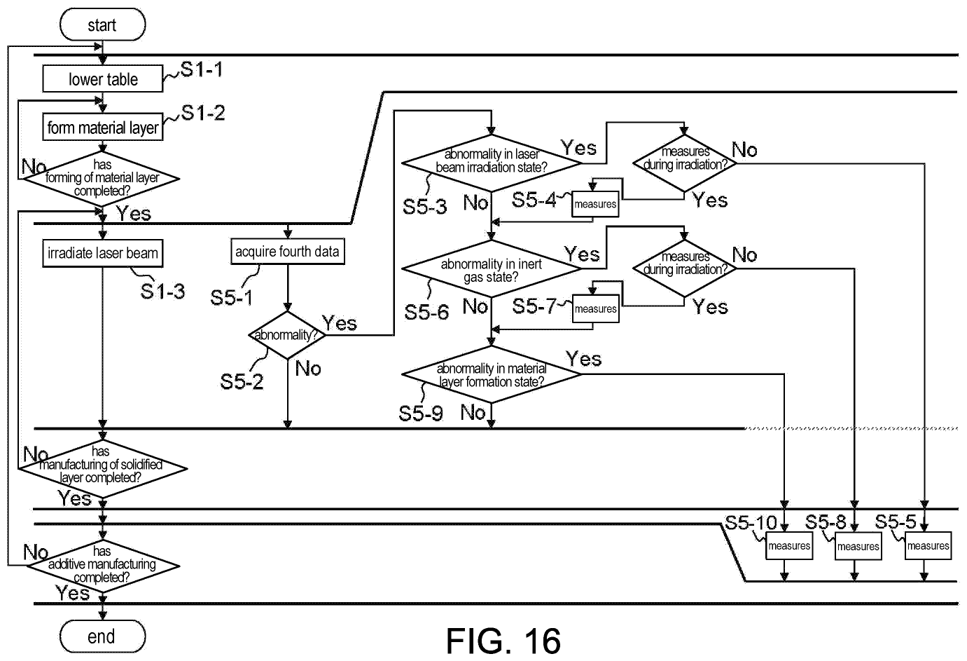

As shown in FIG. 16, the monitoring of the manufacturing state of the solidified layer and the identifying the factor of the abnormality in the manufacturing state are performed in parallel with the production of the additive manufactured object. In parallel with step S1-3, the fourth measurement device 40 measures the temperature T4 of the molten pool relating to the fourth data. The data acquiring device 97 acquires the fourth data in real time (step S5-1). The fourth data is sent to the determination device 91c and the determination device 91c compares the temperature T4 of the molten pool with the allowable range defined by the upper limit value and the lower limit value to determine whether or not there is an abnormality in the manufacturing state in real time (step S5-2). Here, step S5-1 is the above-described data acquiring step. step S5-2 is the above-described determination step.

When it is determined that there is an abnormality in the manufacturing state, the determination device 91c identifies the factor of the abnormality based on the first to third data acquired by the data acquiring device 97 in steps S2-1, 3-1, and 4-1. Specifically, the temperature T1 of the chamber window 21 is compared with the first upper limit value T1, max1 to determine whether or not there is an abnormality in the irradiation state of the laser beam L (step S5-3). When it is determined that there is an abnormality in the irradiation state of the laser beam L, measures to resolve the abnormality are performed (steps S5-4 and S5-5). As the corresponding measures, the same measures as steps S2-3 and S2-4 are supposed. Here, step S5-3 is the above-described determination step.

Further, the fume concentration C in the chamber 2 is compared with the first upper limit value Cmax1 to determine whether or not there is an abnormality in the inert gas state (step S5-6). When it is determined that there is an abnormality in the inert gas state, measures to resolve the abnormality are performed (steps S5-7 and S5-8). As the corresponding measures, the same steps as steps S3-3 and S3-4 are supposed. Here, step S5-6 is the above-described determination step.

Further, the number N of the exposed positions on the metal surface is compared with the first upper limit value Nmax1 to determine whether or not there is an abnormality in the formation state of the material layer 8 (step S5-9). When it is determined that there is an abnormality in the formation state of the material layer 8, measures to resolve the abnormality are performed (step S5-10). As the corresponding measures, for example, the measures will be taken from the time when the next material layer 8 is formed, but it is supposed to improve the uniformity of the material layer 8 by correcting the upper limit value usually used to monitor the formation state of the material layer 8 in the monitoring of the operating state of the additive manufacturing apparatus 1 to a strict value. For example, the value of the second upper limit value Nmax2 may be corrected to be low. Here, step S5-9 is the above-described determination step.

When the operating state and the manufacturing state are normal or the manufacturing of the first solidified layer is completed after the abnormality is resolved by taking the above-described measures, the manufacturing table 5 is lowered by one material layer (step S1-1). Subsequently, the same method as described above is repeated to form the second and subsequent layers. Additionally, when the recoater head 32 of this embodiment in step S1-2 waits on the right side of the manufacturing region R at the time of starting the formation of the material layer 8, the recoater head moves from the right side to the left side of the manufacturing region R to form the material layer 8 and then waits on the left side of the manufacturing region R again. On the other hand, when the recoater head waits on the left side of the manufacturing region R at the time of starting the formation of the material layer 8, the recoater head moves from the left side to the right side of the manufacturing region R to form the material layer 8 and then waits on the right side of the manufacturing region R again. After the additive manufacturing is completed, it is possible to obtain an additive manufactured object by discharging unsolidified material powder and cutting chips.

Additionally, for convenience of description in FIG. 16, steps S5-3, S5-6, and S5-9 are shown in series in this order, but the procedure for identifying the factor of the abnormality in the manufacturing state is not limited thereto. These steps may be performed in an order different from FIG. 16 or may be performed in parallel.

Further, a stop operation, a predetermined operation, a repeating operation, a setting correction, and an operation command value correction for each of the devices constituting the additive manufacturing apparatus 1 performed as the measures when it is determined that there is an abnormality may be performed during the manufacturing of the solidified layer by the irradiation of the laser beam L or may be performed until the manufacturing of the next layer starts after the manufacturing of a certain solidified layer is completed. In addition, it is assumed that the above-described measures will be taken either manually or automatically. In the manual case, an operator of the additive manufacturing apparatus 1 performs appropriate measures based on the determination result of the abnormality in the operating state, the determination result of the abnormality in the manufacturing state, and the identification result of the factor of the abnormality in the manufacturing state displayed on the display device 92. In the automatic case, the calculation device 91b of the numerical control device 91 may be configured to calculate a correction value relating to the operation command based on the determination result and the like sent from the determination device 91c and at least one of the first to third data sent from the data acquiring device 97. Further, the correction value may be calculated in real time during the operation of the additive manufacturing apparatus 1 and the corrected operation command may be output to the control device of each of the devices constituting the additive manufacturing apparatus 1. Further, in the automatic case, a stop operation, a predetermined operation, and a repeating operation of each of the devices constituting the additive manufacturing apparatus 1 may be performed based on the determination result sent from the determination device 91c.

The embodiment was chosen in order to explain the principles of the disclosure and its practical application. Many modifications and variations are possible in light of the above teachings. It is intended that the scope of the disclosure be defined by the claims.

What is claimed is:

1. An additive manufacturing apparatus comprising:
a chamber;
a manufacturing table;
an inert gas supply device;
a fume collector;
a recoater head;
a laser irradiation device;
a data acquiring device; and
a determination device,
wherein the chamber covers a manufacturing region, has a chamber window provided on a ceiling, and is filled with an inert gas having a predetermined concentration,
the manufacturing table is disposed in the manufacturing region and moves in an up and down direction,
the recoater head forms a material layer by supplying material powder onto the manufacturing region,
the laser irradiation device forms a solidified layer by irradiating a manufacturing position of the material layer with a laser beam through the chamber window,
the inert gas supply device supplies a new inert gas into the chamber,
the fume collector removes fume from an inert gas discharged from the chamber together with the fume generated when forming the solidified layer and returns the inert gas from which the fume is removed to the chamber,
the data acquiring device acquires at least one of first data showing an irradiation state of the laser beam, second data showing an inert gas state, and third data showing a formation state of the material layer and fourth data showing a manufacturing position state by measurement, and
the determination device determines whether or not there is an abnormality in a manufacturing state of the solidified layer based on the fourth data and when it is determined that there is an abnormality in the manufacturing state, factors of abnormalities from an operating state of the additive manufacturing apparatus to the manufacturing state of the solidified layer are identified based on at least one of the acquired first to third data.

2. The additive manufacturing apparatus according to claim 1,
wherein the first data is at least one of a temperature of the chamber window, laser power of the laser beam, a scanning speed of the laser beam, a beam diameter of the laser beam, and an irradiation timing of the laser beam.

3. The additive manufacturing apparatus according to claim 1,
wherein the second data is at least one of a fume concentration in the inert gas in the chamber, a wind speed of the inert gas in the chamber, an oxygen concentration in the inert gas in the chamber, a fume concentration in the inert gas discharged from the chamber, and a fume concentration in the inert gas returned from the fume collector to the chamber.

4. The additive manufacturing apparatus according to claim 1,
wherein the third data is at least one of uniformity of a surface of the material layer, a manufactured thickness of the material layer, and a load at the time of operating the recoater head.

5. The additive manufacturing apparatus according to claim 1,
wherein the fourth data is at least one of a temperature of a molten pool formed at the manufacturing position, appearance properties of an irradiation spot formed at the manufacturing position during the irradiation of the laser beam, image data of appearance properties of a spatter generated during the irradiation of the laser beam, and a depth of a keyhole formed at the manufacturing position.

6. The additive manufacturing apparatus according to claim 1,
wherein the data acquiring device acquires the first data, and
the determination device determines whether or not there is an abnormality in the manufacturing state by comparison with a predetermined threshold value or a predetermined allowable range based on the fourth data in real time during the irradiation of the laser beam and when it is determined that there is an abnormality in the manufacturing state, the determination device further determines whether or not there is an abnormality in the irradiation state of the laser beam by comparison with a predetermined threshold value or a predetermined allowable range based on the first data.

7. The additive manufacturing apparatus according to claim 1,
wherein the data acquiring device acquires the second data, and
the determination device determines whether or not there is an abnormality in the manufacturing state by comparison with a predetermined threshold value or a predetermined allowable range based on the fourth data in real time during the irradiation of the laser beam and when it is determined that there is an abnormality in the manufacturing state, the determination device further determines whether or not there is an abnormality in the inert gas state by comparison with a predetermined threshold value or a predetermined allowable range based on the second data.

8. The additive manufacturing apparatus according to claim 1,
wherein the data acquiring device acquires the third data, and
the determination device determines whether or not there is an abnormality in the manufacturing state by comparison with a predetermined threshold value or a predetermined allowable range based on the fourth data in real time during the irradiation of the laser beam and when it is determined that there is an abnormality in the manufacturing state, the determination device further determines whether or not there is an abnormality in the formation state of the material layer by comparison with a predetermined threshold value or a predetermined allowable range based on the third data.

9. The additive manufacturing apparatus according to claim 1,
wherein the additive manufacturing apparatus performs at least one of a stop operation, a predetermined operation, a repeating operation, a setting correction, and an operation command value correction based on the factor identified by the determination device.

10. The additive manufacturing apparatus according to claim 9,
wherein the operation command value correction is performed in real time during the operation of the additive manufacturing apparatus based on at least one of the first to third data.

11. A method of producing an additive manufactured object comprising:
forming a material layer by supplying material powder onto a manufacturing region by a recoater head in a chamber which covers the manufacturing region, has a chamber window provided on a ceiling, and is filled with an inert gas having a predetermined concentration,
forming a solidified layer by irradiating a manufacturing position of the material layer with a laser beam through the chamber window,
acquiring at least one of first data showing an irradiation state of the laser beam, second state showing an inert gas state, and third data showing a formation state of the material layer and fourth data showing a manufacturing position state by measurement, and
determining whether or not there is an abnormality in a manufacturing state of the solidified layer based on the fourth data; and identifying factors of abnormalities from an operating state of an additive manufacturing apparatus to the manufacturing state of the solidified layer based on at least one of the acquired first to third data when the abnormality in the manufacturing state is determined.

12. The method of producing an additive manufactured object according to claim 11,
wherein the first data is at least one of a temperature of the chamber window, laser power of the laser beam, a scanning speed of the laser beam, a beam diameter of the laser beam, and an irradiation timing of the laser beam.

13. The method of producing an additive manufactured object according to claim 11, further comprising:
supplying a new inert gas into the chamber by an inert gas supply device, and
removing fume from an inert gas discharged from the chamber together with the fume generated at the time of forming the solidified layer by a fume collector and returning the inert gas from which the fume is removed to the chamber again,
wherein the second data is at least one of a fume concentration in the inert gas in the chamber, a wind speed of the inert gas in the chamber, an oxygen concentration in the inert gas in the chamber, a fume concentration in the inert gas discharged from the chamber, and a fume concentration in the inert gas returned from the fume collector to the chamber.

14. The method of producing an additive manufactured object according to claim 11,
wherein the third data is at least one of uniformity of a surface of the material layer, a manufactured thickness of the material layer, and a load at the time of operating the recoater head.

15. The method of producing an additive manufactured object according to claim 11,
wherein the fourth data is at least one of a temperature of a molten pool formed at the manufacturing position, appearance properties of an irradiation spot formed at the manufacturing position during the irradiation of the laser beam, image data of appearance properties of a spatter generated during the irradiation of the laser beam, and a depth of a keyhole formed at the manufacturing position.

16. The method of producing an additive manufactured object according to claim 11, further comprising:
acquiring the first data, and
determining whether or not there is an abnormality in the manufacturing state by comparison with a predetermined threshold value or a predetermined allowable range based on the fourth data in real time during the irradiation of the laser beam; and
further determining whether or not an abnormality in the irradiation state of the laser beam by comparison with a predetermined threshold value or a predetermined allowable range based on the first data when the abnormality in the manufacturing state is determined.

17. The method of producing an additive manufactured object according to claim 11, further comprising:
acquiring the second data, and
determining whether or not there is an abnormality in the manufacturing state by comparison with a predetermined threshold value or a predetermined allowable range based on the fourth data in real time during the irradiation of the laser beam; and
further determining whether or not there is an abnormality in the inert gas state by comparison with a predetermined threshold value or a predetermined allowable range based on the second data when the abnormality in the manufacturing state is determined.

18. The method of producing an additive manufactured object according to claim 11, further comprising:
acquiring the third data, and
determining whether or not there is an abnormality in the manufacturing state by comparison with a predetermined threshold value or a predetermined allowable range based on the fourth data in real time during the irradiation of the laser beam; and
further determining whether or not there is an abnormality in the formation state of the material layer by comparison with a predetermined threshold value or a predetermined allowable range based on the third data when the abnormality in the manufacturing state is determined.

19. The method of producing an additive manufactured object according to claim 11,
wherein the additive manufacturing apparatus performs at least one of a stop operation, a predetermined operation, a repeating operation, a setting correction, and an operation command value correction based on the identified factors of abnormalities.

20. The method of producing an additive manufactured object according to claim 19,
wherein the operation command value correction is performed in real time during the operation of the additive manufacturing apparatus based on at least one of the first to third data.
